(19) United States
(12) Patent Application Publication
(10) Pub. No.: US 2021/0149688 A1
(43) Pub. Date: May 20, 2021

(54) SYSTEMS AND METHODS FOR IMPLEMENTING EXTERNAL APPLICATION FUNCTIONALITY INTO A WORKFLOW FACILITATED BY A GROUP-BASED COMMUNICATION SYSTEM

(71) Applicant: Slack Technologies, Inc., San Francisco, CA (US)

(72) Inventors: Leslie Newell, Aurora, CO (US); Michael Brevoort, Littleton, CO (US); Diogenes Brito, New York, NY (US); Brad Harris, Denver, CO (US); Chris Skudlarczyk, Denver, CO (US)

(21) Appl. No.: 17/067,290

(22) Filed: Oct. 9, 2020

Related U.S. Application Data
(60) Provisional application No. 62/937,137, filed on Nov. 18, 2019.

(51) Int. Cl. G06F 9/445; G06Q 10/10; G06F 40/174

(52) U.S. Cl. CPC G06F 9/44526; G06F 40/174; G06Q 10/103; G06Q 10/1093

(57) ABSTRACT

Integrating applications into a communication system via steps of workflows is described. In an example, the communication system can receive a request to integrate a functionality of an application into the communication system via an application extension. The functionality can be associated with a step to be integrated in a workflow. Responsive to receiving the request, the communication system can cause an input user interface to be presented via the computing device, wherein the input user interface is configured to receive application extension data. Based at least in part on associating the application extension data with a trigger event identifier, the communication system can store an indication of the step in a repository and cause a selectable user interface element associated with the step to be presented via a group-based communication interface. Selection of the selectable user interface element can cause the step to be included in the workflow.

### PRIORITY

This application claims priority to U.S. Provisional Patent Application No. 62/937,137, filed on Nov. 18, 2019, the entire contents of which are incorporated by reference herein.

### TECHNICAL FIELD

Systems have been provided for implementing application functionality into a workflow facilitated by a group-based communication system.

Through applied effort, ingenuity, and innovation many deficiencies of such systems have been solved by developing solutions that are in accordance with techniques discussed herein, many examples of which are described in detail herein.

### BRIEF DESCRIPTION OF THE DRAWINGS

Reference will now be made to the accompanying drawings, which may not be drawn to scale, and wherein:

FIG. 1 illustrates a schematic view of a system encompassing a group-based communication system in communication with one or more client devices in accordance with one embodiment.

FIG. 2 illustrates an apparatus of a group-based communication server(s) in accordance with one embodiment.

FIGS. 3A-3B illustrate a lane diagram showing functionality of various components in accordance with various embodiments.

FIG. 4 is a flowchart illustrating example steps for executing an example workflow associated with a group-based communication system.

FIG. 5 is a flowchart illustrating example steps for executing another example workflow associated with a group-based communication system.

FIG. 6 shows an example group-based communication interface providing a group-based communication channel interface.

FIG. 7 shows an example group-based communication interface providing a workflow builder user interface for adding steps to a workflow.

FIG. 8 shows an example group-based communication interface providing a workflow builder user interface for generating and/or modifying a workflow.

FIG. 9 shows an example group-based communication interface providing a settings user interface for configuring settings associated with workflow generation.

Below, the detailed description more fully describes various examples with reference to the accompanying drawings. It should be understood that some, but not all examples are shown and described herein. Indeed, the examples may take many different forms, and accordingly this disclosure should not be construed as limited to the examples set forth herein. Rather, these examples are provided so that this disclosure will satisfy applicable legal requirements.

### DETAILED DESCRIPTION

Integrating application functionality into a workflow initialized and executed, at least in part, by a group-based communication system is described. In at least one example, the group-based communication system can be a channel-based messaging platform and/or any other system for facilitating communication. Techniques described herein are directed to systems and methods for enabling the incorporation of at least one functionality of an application into a group-based communication system for facilitating the communication and transfer of data between a group-based communication server of a group-based communication system and the application such that the application functionality can be executable as part of a workflow at the group-based communication system. In some examples, the application can be an “external” application, such that the application is a third-party application that is external to the group-based communication system. In other examples, the application can be “native” to the group-based communication system. As described herein, such application functionality can be associated with one or more steps that can be used to generate workflows at the group-based communication system. Such workflows can comprise a plurality of steps that when executed, in a sequence, cause a task to be performed. Steps of a workflow can be associated with one or more applications, external and/or native applications, or the like.

Techniques described herein are directed to providing application developers, or other entities associated with applications, the ability to create custom workflows by designating particular steps to include in workflows, orders of steps to include in workflows, trigger events for triggering workflows and/or individual steps associated therewith. That is, in an example, the group-based communication system can provide application developers, or other entities associated with applications, the ability to create custom workflow triggers and/or steps that can be used by users of the group-based communication system for generating user-generated workflows. In some examples, the workflow triggers and/or steps can be native to the group-based communication system. In some examples, the workflow triggers and/or steps can be non-native (i.e., external). Such workflow triggers and/or steps can be provided by third-party applications that are external to the group-based communication system. In such examples, an application developer, or other entity associated with the application, can utilize an application extension that is part of the configuration of the application to provide workflow triggers and/or steps that can be integrated into workflows of the group-based communication system. As described below, workflow triggers and/or steps can be stored in a repository (e.g., a library) and can be searchable or otherwise discoverable for integration into user-defined workflows via a workflow builder functionality described herein.

In an example, steps (e.g., indications thereof) provided by application developers and/or the group-based communication system can be stored in a repository associated with the group-based communication system. A user can interact with a user interface (e.g., a workflow builder user interface) to build a workflow by adding one or more steps to the workflow. The user interface can present user interface elements representative of steps that can be selectably added to the workflow. Based at least in part on detecting selections of individual steps, the group-based communication system can generate a workflow. Such workflows can be referred to as “user-generated workflows,” and, in some examples, such workflows can be stored in the repository for use by other users of the group-based communication system. In at least one example, a workflow can be initialized based on a trigger event associated with the workflow and/or a step associated therewith and/or based at least in part on a user requesting to initialize the workflow via an interaction with a group-based communication user interface.

As discussed herein, certain examples of the present disclosure are directed to systems and methods of incorporating an application extension corresponding to a functionality of an application, which can be external to a group-based communication system into the group-based communication system.

For purposes of this discussion, the term “application” can refer to a software program, application, platform, or service that is configured to communicate with the group-based communication system and which service, manage, and/or perform actions that form various functions of an application that is accessible to a client device via a group-based communication interface. In an example, an application can operate on a compiled code base or repository that is separate and distinct from that which supports the group-based communication system. An application may comprise additional storage repositories (e.g., databases) associated with tasks, functions, and/or actions that may be performed via an associated application system. In some examples, an application system may communicate with the group-based communication system, and vice versa, through one or more application program interfaces (APIs). In some examples, the application receives tokens or other authentication credentials that are used to facilitate secure communication between the application and the group-based communication system in view of group-based communication system network security layers or protocols (e.g., network firewall protocols). As various examples, an application may be configured for executing a calendaring/scheduling app, a to-do list app, a service provider app, a software testing app, a storage repository app, and/or the like.

As described herein, it should be understood that the term “application” may be user to refer to either an external application (e.g., an application associated with a third-party) or an internal application (i.e. an application hosted within the group-based communication server). An internal application can also be referred to as a “native” application. An application may be configured to execute an application workflow step associated with a workflow identifier initialized in the group-based communication system and/or the application by utilizing an application extension.

In at least one example, each application can be associated with an application identifier, which can comprise one or more items of data by which an application may be uniquely identified. For example, an application identifier may comprise ASCII text, a pointer, a memory address, and the like. In at least one example, a collection of data associated with an application that is capable of being transmitted, received, and/or stored can be referred to as “application data.” Application data may comprise data associated with an application system which defines the implementation and/or functionality of the application within the group-based communication system. For example, application data may comprise processing action data, application informational data, application settings data, application home interface configuration data, application contextual data (e.g., application home interface contextual data), and/or the like. In certain examples, application data may be configured by a developer associated with an application and/or a group-based communication server, as described herein.

Techniques described herein are described as being “group-based,” which can refer to a system, channel, message, or virtual environment that has security sufficient such that it is accessible only to a defined group of users. The group may be defined by common access credentials such as those of an organization or commercial enterprise. Access may further be facilitated by a validated request to join or an invitation to join transmitted by one group member user to another non-member user. Group identifiers (defined below) are used to associate data, information, objects, messages, etc., with specific groups.

A group-based communication system can be a system through which client devices may communicate and interact in a group-based setting. The group-based communication system may comprise a collection of computing services that are accessible to one or more client devices, and that are operable to provide access to a plurality of software applications related to operations of databases. In some examples, the group-based communication system may take the form of one or more central servers disposed in communication with one or more additional servers running software applications, and having access to one or more databases storing digital content items, application-related data, and/or the like. The group-based communication system may also support client retention settings and other compliance aspects. Further, the group-based communication system may provide comprehensive third-party developer support that grants appropriate access to the data and allows third parties to build applications and bots to integrate with workflows as described herein.

Group-based communication system users can be organized into organization groups (e.g., employees of each company may be a separate organization group) and each organization group may have one or more communication channels (e.g., group-based communication channels) to which users may be assigned or which the users may join (e.g., group-based communication channels may represent departments, geographic locations such as offices, product lines, user interests, topics, issues, and/or the like). A group identifier may be used to facilitate access control for a message (e.g., access to the message, such as having the message return as part of search results in response to a search query, may be restricted to those users having the group identifier associated with their user profile). The group identifier may be used to determine context for the message (e.g., a description of the group, such as the name of an organization and/or a brief description of the organization, may be associated with the group identifier).

Group-based communication system users may join and/or create communication channels (e.g., group-based communication channels). Some group-based communication channels may be globally accessible to those users having a particular organizational group identifier associated with their user profile (i.e., users who are members of the organization). Access to some group-based communication channels may be restricted to members of specified groups, whereby the group-based communication channels are accessible to those users having a particular group identifier associated with their user profile. The group-based communication channel identifier may be used to facilitate access control for a message (e.g., access to the message, such as having the message return as part of search results in response to a search query, may be restricted to those users having the group-based communication channel identifier associated with their user profile, or who have the ability to join the group-based communication channel). The group-based communication channel identifier may be used to determine context for the message (e.g., a description of the group-based communication channel, such as a description of a project discussed in the group-based communication channel, may be associated with the group-based communication channel identifier).

A group-based communication server may allow for a user to construct a workflow defined by various workflow steps at least partially executable by the group-based communication server. In at least one example, group-based communication server(s) can be one or more computing devices configured for interacting with various client devices for receiving and/or disseminating messages for distribution within communication channels. Group-based communication server(s) may be configured to receive, store (in an associated database), and/or direct messages exchanged between users (operating via client devices). The functionality of the group-based communication server(s) may be provided via a single server or collection of servers having a common functionality, or the functionality of the group-based communication server(s) may be segmented among a plurality of servers or collections of servers performing subsets of the described functionality of the group-based communication server(s). For example, a first subset of group-based communication server(s) may be configured for receiving messages from client devices and/or for transmitting messages to client devices (e.g., via one or more interface servers). These group-based communication server(s) may be in communication with a second subset of group-based communication server(s) configured for collecting messages distributed within communication channels and for storing those messages within a message repository database for indexing and archiving. Additional details are provided below.

As described herein, the group-based communication system may be configured to facilitate generation of application extension data that enables a developer-defined functionality of an application to be selectably incorporated into a workflow initialized by the group-based communication system. In at least one example, application extension data can comprise a collection of data associated with an application extension that is capable of being transmitted, received, and/or stored. Application extension data may comprise data associated with an application system which defines the implementation and/or functionality of the application within a group-based communication system. In certain examples, application data may be configured by a developer associated with an application and/or a group-based communication server based at least in part on developer input at an interactive extension creation interface rendered within the group-based communication interface.

Additionally, the group-based communication system may be configured to facilitate the execution of a workflow initialized within the external application, based at least in part on application extension data (e.g., a developer-defined, application-based trigger event) associated with an application as configured by an application developer. A workflow can comprise one or more steps that, when executed, cause the completion of a task. In an example, a workflow can be associated with workflow data, a collection of data associated with a workflow that is capable of being transmitted, received, and/or stored. Workflow data may comprise data which defines the functionality of the workflow associated therewith. In various examples, workflow data may comprise workflow step data, which defines the functionality of the associated workflow step. A workflow step can be referred to as a “step” throughout this disclosure. In certain examples, workflow data may be configured by a workflow creator. In certain examples, workflow data may be associated with a workflow identifier, application extension data, application data, a user identifier, a workflow generation request, and/or a selectable workflow element. In some examples, each workflow can be associated with a workflow identifier, which can refer to one or more items of data by which a workflow may be uniquely identified. For example, a workflow identifier may comprise ASCII text, a pointer, a memory address, and the like.

Application extension data may be generated by a developer associated with the application through developer input at an interactive extension creation interface (e.g., an input interface) rendered within the group-based communication interface. In at least one example, the interactive extension creation interface can comprise one or more interface elements renderable to display an area by which a developer associated with an application may enter data to implement and/or configure various aspects of an application (e.g., an application extension) within a group-based communication system. That is, an interactive extension creation interface can be a user interface for receiving input associated with application extension data. An interactive extension creation interface may be rendered within a group-based communication interface at a client device associated with the developer. The interactive extension creation interface may be configured to accept user input from the developer client device. The developer user input defining, at least in part, the application extension data.

The application extension data may correspond to the developer input and may be stored in a group-based communication repository. In at least one example, the group-based communication repository can be a computing location where data is stored, accessed, modified and otherwise maintained by the group-based communication system. The stored data includes information that facilitates the operation of the group-based communication system. The group-based communication repository may be embodied as a data storage device or devices, as a separate database server or servers, or as a combination of data storage devices and separate database servers. Further, in some examples, the group-based communication repository may be embodied as a distributed repository such that some of the stored data is stored centrally in a location within the group-based communication system and other data stored in a single remote location or a plurality of remote locations. Alternatively, in some examples, the group-based communication repository may be distributed over a plurality of remote storage locations only.

An application extension may be bundled with the application in the group-based communication system such that when a user installs the application to enable execution of the application in association with a channel, a group, a user, and/or the like, the user may selectively configure a workflow comprising an application workload step and executable by the application. In some examples, as described below, application extensions and/or associated steps can be searchable via a search mechanism associated with the group-based communication interface such that individual of the application extensions and/or steps can be identified and added to user-generated workflows, as described herein.

Upon detecting a trigger event configured to initialize an application workflow step, the group-based communication server may generate an application extension data packet configured as a transferable function signature so as to facilitate the execution of the application workflow step by the application. In at least one example, the term “data packet” as used herein refers to a collection of individual data elements that may be transmitted between a plurality of computing entities collectively, such that the included data remains associated therewith. The data packet may be configured to store data (e.g., routing data) therein with a standardized formatting, such that computing entities may be configured to automatically determine the type of data stored within the data packet. For example, a data packet may comprise substantive data to be passed between computing entities stored within a payload of the data packet, and the data packet may comprise metadata associated with the generation of the data packet that is stored within a routing data portion of the data packet. An application extension data packet may be selectively configured by the group-based communication server as a transferable function signature so as to facilitate the execution of the application workflow step by an application. The elements of the transferable function signature may be defined at least in part based on the aforementioned developer input at the interactive extension creation interface. The application extension data packet may further comprise various data required by the application to execute the corresponding application workflow step. For example, the application extension data packet may comprise a user identifier associated with the client device 102, the workflow identifier, the application extension data string, at least a portion of the results data associated with the workflow identifier, the application extension callback identifier, and the application extension callback URL.

In at least one example, the elements of the transferable function signature (e.g., associated with the application extension data packet) may be defined at least in part based on the aforementioned developer input at the interactive extension creation interface. The application extension data packet may further comprise various data utilized by the application to execute the corresponding application workflow step. For example, the application extension data packet may comprise one or more of a user identifier associated with the selection of the workflow, a workflow identifier, an application extension data string, results data generated from subsequently executed workflow steps associated with the workflow identifier, an application extension callback identifier, and an application extension callback URL. Upon execution of the application workflow step by the application, the application may transmit the outputs generated by the transferable function signature to the group-based communication server using the application extension callback URL, which may be specifically associated with the application workflow step corresponding to the application extension.

In some examples, a workflow can be actuated or otherwise initialized based at least in part on actuation of a selectable workflow element. In at least one example, a selectable workflow element can be a discrete user interface element (e.g., a selectable button) corresponding to a workflow that is presented to a user as a part of a group-based communication interface. In certain examples, a selectable workflow element may be configured to initialize a workflow associated therewith upon being selected via user input from a client device. In certain examples, a selectable workflow element may be selectively presented throughout a group-based communication interface.

In at least one example, a group-based communication interface can be a virtual communications environment configured to facilitate user interaction with the group-based communications system. Each group-based communication interface is accessible and viewable to a select group of users, such as a group of employees of a business or organization (e.g., a BETA Corporation interface would be accessible and viewable to the BETA employees; however the ACME Corporation group-based communication interface would not be accessible and viewable to BETA employees). The group-based communication interface includes a plurality of group-based communication channels (e.g., a marketing channel, sales channel, accounting channel, etc.), which are defined herein.

Methods, apparatuses, and computer program products of the present invention may be embodied by any of a variety of devices. For example, the method, apparatus, and computer program product of an example may be embodied by a network device, such as a server or other network entity, configured to communicate with one or more devices, such as one or more client devices. In some preferred and non-limiting examples, the computing device may include fixed computing devices, such as a personal computer or a computer workstation. Still further, example examples may be embodied by any of a variety of mobile devices, such as a portable digital assistant (PDA), mobile phone, smartphone, laptop computer, tablet computer, wearable device, or any combination of the aforementioned devices.

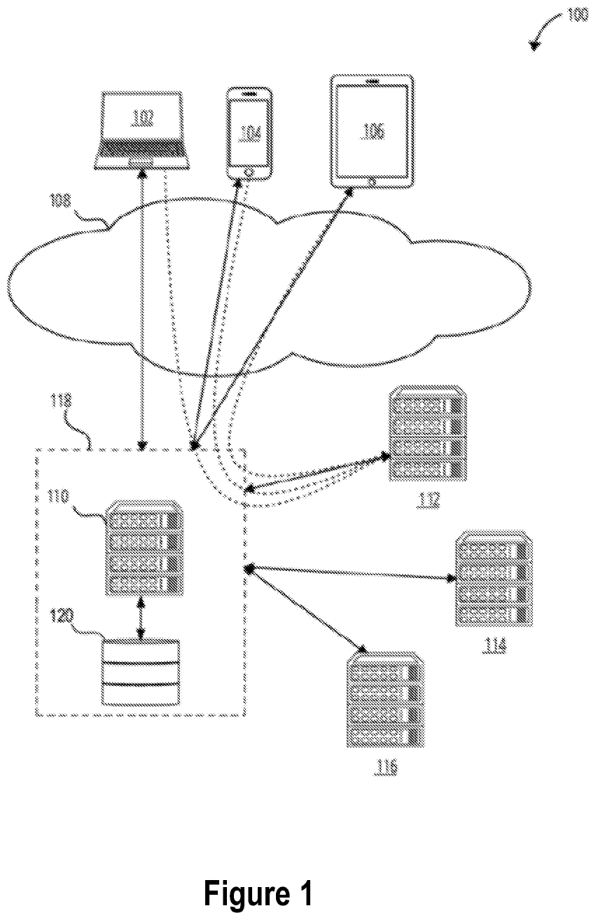

FIG. 1 illustrates an example computing system 100 within which examples of the present invention may operate. Users may access a group-based communication system 118 via a communication network 108 using client devices 102-106. A user can be an individual, a group of individuals, business, organization, and/or the like. Users may access the group-based communication or messaging system using the client devices 102-106. In at least one example, “group-based” can be used herein to refer to a system, channel, message, or virtual environment that has security sufficient such that it is accessible only to a defined group of users. The group may be defined by common access credentials such as those of an organization or commercial enterprise. Access may further be facilitated by a validated request to join or an invitation to join transmitted by one group member user to another non-member user. Group identifiers (defined below) are used to associate data, information, messages, etc., with specific groups. For example, a user may comprise a developer user associated with an application.

Communication network 108 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, communication network 108 may include a cellular telephone, an 802.11, 802.16, 802.20, and/or WiMax network. Further, the communication network 108 may include a public network, such as the Internet, a private network, such as an intranet, or combinations thereof, and may utilize a variety of networking protocols now available or later developed including, but not limited to TCP/IP based networking protocols. As discussed herein, the networking protocol is configured to enable data transmission via websocket communications. For instance, the networking protocol may be customized to suit the needs of the group-based communication system. In some examples, the protocol is a custom protocol of JSON objects sent via a websocket channel. In some examples, data may be transmitted via a plurality of protocols, such as JSON over RPC, JSON over REST/HTTP, and the like.

In the illustrated example, the group-based communication system 118 includes one or more group-based communication server 110 accessible via the communication network 108. Collectively, the at least one group-based communication server(s) 110 is configured for receiving messages transmitted from one or more client devices 102-106, storing the messages within a group-based communication repository for individual communication channels, and/or for transmitting messages to appropriate client devices 102-106. Moreover, the group-based communication system 118 can include a group-based communication repository 120 (which can be referred to as the “repository”), which may define one or more cache memory storage areas and/or one or more long term storage areas, such as for storing historical data utilized for executing one or more models as discussed herein. In some examples, the group-based communication repository 120 can store indications of steps (e.g., which can be associated with application extension data, a trigger event identifier, and the like). In at least one example, the group-based communication repository 120 can store a plurality of such indications and can therefore comprise a “library.” In at least one example, indications of steps stored in the library can be searchable via a user interface associated with the group-based communication system (e.g., a user interface presented in association with a workflow builder available via the user interface). In some examples, the steps are associated with a corresponding application such that a user can search for steps related to an application by searching by application name, a functionality, or the like. In some examples, steps of related applications are also displayed in the search results (e.g., steps and/or other applications that are relevant to the search, such as by having a same or similar name, functionality, or the like).

In at least one example, the group-based communication repository 120 can store a group-based communication data corpus, which can be a collection of data that has been received by the group-based communication system 118 through group-based communication interfaces. In some examples, a group-based communication system data corpus may comprise one or more of a group-based communication data work objects, group-based communication messages, group-based communication channels, and user profiles associated with the group-based communication system.

In at least one example, a group-based communication object, a group-based communication data object, and/or a group-based communication data work object can individual comprise data and/or instructions that represent an item or resource of the group-based communication system 118. Each group-based communication object has an object identifier that uniquely identifies a particular group-based communication object in the group-based communication system 118 and an object type, which describes the category of objects to which the group-based communication object belongs. In some examples, users may perform actions via a group-based communication interface that create or modify group-based communication objects. Example group-based communication objects include group-based communication channels, user profile identifiers, indications of user profiles (such as pointers with reference to user profiles), files created and maintained in the group-based communication system 118, files linked or uploaded to the group-based communication system 118, user accounts, emojis posted in a group-based communication channel, emojis available in a group-based communication channel, metadata associated with group-based communication messages such as author identifiers, a post timestamp, a channel identifier, user identifiers of users with access rights to the group-based communication message, and the like.

For the purpose of this discussion, a “timestamp” can be a digital representation of network time associated with an occurrence or action within the group-based communication system 118. For example, workflow step timestamp may correspond to the network time at which a workflow step was executed. Workflow step timestamp may define at least a portion of the results data associated with a workflow identifier. The timestamp may be analyzed to determine context associated with the workflow step.

In at least one example, “data,” as used herein, can refer to data capable of being transmitted, received, and/or stored in accordance with examples of the present disclosure. Thus, use of any such terms should not be taken to limit the spirit and scope of examples of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like. Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

As described above, in some examples, the group-based communication repository 120 can store user profiles (which can be alternatively referred to as “user accounts” and/or “user account details”). In at least one example, a user profile can comprise information associated with a user, including, for example, a user identifier, one or more group-based communication channel identifiers associated with group-based communication channels that the user has been granted access to, one or more group identifiers for groups with which the user is associated, an indication as to whether the user is an owner of any group-based communication channels, an indication as to whether the user has any group-based communication channel restrictions, a plurality of messages, a plurality of emojis, a plurality of conversations, a plurality of conversation topics, a plurality of historical conversation primitives associated with the user profile, an avatar, an email address, a real name (e.g., John Doe), a username (e.g., jdoe), a password, a real name, a time zone, a status, conversation segments associated with the user, metadata indicating historical messages with same conversation primitive shared with other user profiles, a digital signature data structure, and the like. The user account details can include a subset designation of user credentials, such as, for example, login information for the user including the user's username and password.

The client devices 102-106 may be any computing device as defined above. Electronic message data exchanged between the group-based communication server(s) 110 and the client devices 102-106 may be provided in various forms and via various methods.

In at least one example, a client device of the client devices 102-106 can comprise computer hardware and/or software that is configured to access a service made available by a server. The server is often (but not always) on another computer system, in which case the client device accesses the service by way of a network, such as the communication network 108. Client devices can access the group-based communication server(s) 110 via the communication network 110 during “connection sessions” during which the client device maintains an active connection with the group-based communication server(s) 110 for data transfer therebetween. A single connection session may encompass a continuous time period during which the client device maintains a connection with the group-based communication server(s) 110 (e.g., between consecutive interruptions in connection, between consecutive occurrences of establishing and ending a connection, and/or the like). It should be understood that in certain examples, a connection session may continue between consecutive occurrences for establishing and ending a connection between a client device and the group-based communication system, despite the inclusion of one or more short-duration interruptions, during which the client device and/or the group-based communication server(s) 110 is configured to cache any data to be exchanged which is generated and/or retrieved during the short-duration interruption. While a connection session remains active, it may be referred to as a “current connection session.” Once a current connection session ends (e.g., by termination of the connection between the client device and group-based communication server(s) 110) the current connection session becomes a prior connection session. Connection sessions may have associated unique “session identifiers,” thereby enabling a client device and/or group-based communication server(s) 110 to distinguish between a current connection session and prior connection sessions. These session identifiers may be alphanumeric strings (or other unique identifiers) that are unique to a particular session.

In some examples, one or more of the client devices 102-106 are mobile devices, such as smartphones or tablets. The one or more client devices may execute an application or “app” to interact with the group-based communication server(s) 110. Such apps are typically designed to execute on mobile devices, such as smartphones or tablets. For example, an app may be provided that executes on mobile device operating systems such as Apple Inc.'s iOS®, Google Inc.'s Android®, or Microsoft Inc.'s Windows 10 Mobile®. These platforms typically provide frameworks that allow apps to communicate with one another, and with particular hardware and software components of mobile devices. For example, the mobile operating systems named above each provides frameworks for interacting with location services circuitry, wired and wireless network interfaces, user contacts, and other applications. Communication with hardware and software modules executing outside of the app is typically provided via application programming interfaces (APIs) provided by the mobile device operating system. Thus, via the app executing on the client devices 102-106, these client devices 102-106 are configured for communicating with the group-based communication system 118.

In some examples, the client devices 102-106 may interact with the group-based communication server(s) 110 via a web browser. The client devices 102-106 may also include various hardware or firmware designed to interact with the group-based communication server(s) 110. Again, via the browser of the client devices 102-106, the client devices 102-106 are configured for communicating with the group-based communication system 118.

In some examples of an example group-based communication system 118, a message or messaging communication may be sent from a client device 102-106 to a group-based communication system 118. In various implementations, messages may be sent to the group-based communication system 118 over communication network 108 directly by one of the client devices 102-106. The messages may be sent to the group-based communication system 118 via an intermediary such as a message server, and/or the like. For example, a client device 102-106 may be a desktop, a laptop, a tablet, a smartphone, and/or the like that is executing a client application (e.g., a group-based communication app). In one implementation, the message may include data such as a message identifier, sending user identifier, a group identifier, a group-based communication channel identifier, message contents (e.g., text, emojis, images, links), attachments (e.g., file objects), message hierarchy data (e.g., the message may be a reply to another message), third-party metadata, and/or the like. In one example, the client device 102-106 may provide the following example message, substantially in the form of a (Secure) Hypertext Transfer Protocol (“HTTP(S)”) POST message including eXtensible Markup Language (“XML”) formatted data, as provided below:

POST /authrequest.php HTTP/1.1
Host: www.server.com
Content-Type: Application/XML
Content-Length: 667
<?XML version = “1.0” encoding = “UTF-8”?>
<auth_request>

<timestamp>2020-12-31 23:59:59</timestamp>
<user_accounts_details>

<user_account_credentials>

<user_name>ID_user_1</user_name>
<password>abc123</password>
//OPTIONAL <cookie>cookieID</cookie>
//OPTIONAL <digital_cert_link>www.mydigitalcertificate.com/

JohnDoeDaDoeDoe@gmail.com/mycertifcate.dc</digital_cert_link>

//OPTIONAL <digital_certificate>_DATA_</digital_certificate>

</user_account_credentials>

</user_accounts_details>
<client_details> //iOS Client with App and Webkit

//it should be noted that although several client details
//sections are provided to show example variants of client
//sources, further messages will include only on to save
//space

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0
Mobile/11D201 Safari/9537.53 </user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UD

ID>

<client_OS>iOS</client_OS>
<client_OS_version>7.1.1</client_OS_version>
<client_app_type>app with webkit</client_app_type>
<app_installed _flag>true</app_installed_flag>
<app_name>MSM.app</app_name>
<app_version>1.0 </app_version>
<app_webkit_name>Mobile Safari</client_webkit_name>
<client_version>537.51.2</client_version>

</client_details>
<client_details> //iOS Client with Webbrowser

<client_IP>10.0.0.123</client_IP>
<user_agent_string>Mozilla/5.0 (iPhone; CPU iPhone OS 7_1_1 like Mac

OS X) AppleWebKit/537.51.2 (KHTML, like Gecko) Version/7.0
Mobile/11D201 Safari/9537.53</user_agent_string>

<client_product_type>iPhone6,1</client_product_type>
<client_serial_number>DNXXX1X1XXXX</client_serial_number>
<client_UDID>3XXXXXXXXXXXXXXXXXXXXXXXXD</client_UD

ID>

<client_OS>iOS</client_OS>
<client_OS_version>7.1.1</client_OS_version>
<client_app_type>web browser</client_app_type>
<client_name>Mobile Safari</client_name>
<client_version>9537.53</client_version>

</client_details>
<client_details> //Android Client with Webbrowser

<client_IP>10.0.0.123</client_IP>
<user_agent_string>Mozilla/5.0 (Linux; U; Android 4.0.4; en-us; Nexus S

Build/IMM76D) AppleWebKit/534.30 (KHTML, like Gecko) Version/4.0 Mobile
Safari/534.30</user_agent_string>

<client_product_type>Nexus S</client_product_type>
<client_serial_number>YXXXXXXXXZ</client_serial_number>
<client_UDID>FXXXXXXXXX-XXXX-XXXX-XXXX-

XXXXXXXXXXXXX</client_UDID>

<client_OS>Android</client_OS>
<client_OS_version>4.0.4</client_OS_version>
<client_app_type>web browser</client_app_type>
<client_name>Mobile Safari</client_name>
<client_version>534.30</client_version>

</client_details>
<client_details> //Mac Desktop with Webbrowser

<client_IP>10.0.0.123</client_IP>
<user_agent_string>Mozilla/5.0 (Macintosh; Intel Mac OS X 10_9_3)

AppleWebKit/537.75.14 (KHTML, like Gecko) Version/7.0.3
Safari/537.75.14</user_agent_string>

<client_product_type>MacPro5,1</client_product_type>
<client_serial_number>YXXXXXXXXZ</client_serial_number>
<client_UDID>FXXXXXXXXX-XXXX-XXXX-XXXX-

XXXXXXXXXXXXX</client_UDID>

<client_OS>Mac OS X</client_OS>
<client_OS_version>10.9.3</client_OS_version>
<client_app_type>web browser</client_app_type>
<client_name>Mobile Safari</client_name>
<client_version>537.75.14</client_version>

</client_details>
<message>

<message_identifier>ID_message_10</message_identifier>
<team_identifier>ID_team_1</team_identifier>
<channel_identifier>ID_channel_1</channel_identifier>
<contents>That is an interesting invention. I have attached a copy our

patent policy.</contents>

<attachments>patent_policy.pdf</attachments>

</message>

</auth_request>

In the illustrated example, the group-based communication system 118 comprises a plurality of group-based communication server(s) 110 configured to receive messages transmitted between a plurality of client devices 102-106 within a group-based communication channel identified by a channel identifier and/or a group identifier, and to facilitate dissemination of those messages among client devices 102-106 that collectively form the membership of the group-based communication channel.

In some examples, data indicating responses may be associated with the message. For example, responses to the message by other users may include reactions (e.g., selection of an emoji associated with the message, selection of a “like” button associated with the message), clicking on a hyperlink embedded in the message, replying to the message (e.g., posting a message to the group-based communication channel interface in response to the message), downloading a file associated with the message, sharing the message from one group-based communication channel to another group-based communication channel, pinning the message, starring the message, and/or the like. In one implementation, data regarding responses to the message by other users may be included with the message, and the message may be parsed (e.g., using PHP commands) to determine the responses. In another implementation, data regarding responses to the message may be retrieved from a database. For example, data regarding responses to the message may be retrieved via a MySQL database command similar to the following:
SELECT messageResponses
FROM MSM_Message
WHERE messageID=ID_message_10.

For example, data regarding responses to the message may be used to determine context for the message (e.g., a social score for the message from the perspective of some user). In another example, data regarding responses to the message may be analyzed to determine context regarding the user (e.g., the user's expertise in a topic may be determined based on the responses to the user's message regarding the topic).

In examples, attachments may be included with the message. If there are attachments, file objects may be associated with the message. In one implementation, the message may be parsed (e.g., using PHP commands) to determine file names of the attachments. For example, file contents may be analyzed to determine context for the message (e.g., a patent policy document may indicate that the message is associated with the topic “patents”).

In examples, third-party metadata may be associated with the message. For example, third-party metadata may provide additional context regarding the message or the user that is specific to a company, group, group-based communication channel, and/or the like. In one implementation, the message may be parsed (e.g., using PHP commands) to determine third-party metadata. For example, third-party metadata may indicate whether the user who sent the message is an authorized representative of the group-based communication channel (e.g., an authorized representative may be authorized by the company to respond to questions in the group-based communication channel).

In examples, a conversation primitive may be associated with the message. In one implementation, a conversation primitive is an element used to analyze, index, store, and/or the like messages. For example, the message may be analyzed by itself, and may form its own conversation primitive. In another example, the message may be analyzed along with other messages that make up a conversation, and the messages that make up the conversation may form a conversation primitive. In one implementation, the conversation primitive may be determined as the message, a specified number (e.g., two) of preceding messages and a specified number (e.g., two) of following messages. In another implementation, the conversation primitive may be determined based on analysis of topics discussed in the message and other messages (e.g., in the channel) and/or proximity (e.g., message send order proximity, message send time proximity) of these messages.

In examples, various metadata, determined as described above, and/or the contents of the message may be used to index the message (e.g., using the conversation primitive) and/or to facilitate various facets of searching (i.e., search queries that return results from the group-based communication server(s) 110). Metadata associated with the message may be determined and the message may be indexed in the group-based communication server(s) 110. In one example, the message may be indexed such that a company's or a group's messages are indexed separately (e.g., in a separate index associated with the group and/or company that is not shared with other groups and/or companies). In one implementation, messages may be indexed at a separate distributed repository (e.g., to facilitate data isolation for security purposes). If there are attachments associated with the message, file contents of the associated files may be used to index such files in the group-based communication server(s) 110 to facilitate searching. In one example, the files may be indexed such that a company's or a group's files are indexed at a separate distributed repository. Similarly, as discussed herein, app data associated with various application systems and/or processing actions may be stored in association with a particular group's messages, such that app data associated with a plurality of groups are stored separately.

Examples of electronic message exchange among one or more client devices 102-106 and the group-based communication system 118 are described below in reference to FIG. 1.

As shown in FIG. 1, the group-based communication system 118 enables individual client devices 102-106 to exchange objects (e.g., messages) with one another and to interact with one or more application systems 112-116. To exchange messages and/or other objects between client devices 102-106, individual client devices 102-106 transmit messages (e.g., text-based messages, file objects, video and/or audio streams, and/or the like) to the group-based communication system 118. Those messages are ultimately provided to one or more group-based communication server(s) 110, which indexes the messages and distributes those messages to the intended recipients (e.g., client devices 102-106) of the message.

In at least one example, a message exchanged via the group-based communication system 118 (e.g., a “group-based communication message”) can refer to any electronically generated digital content object provided by a user that has security sufficient such that it is accessible only to a defined group of users and that is configured for display within a group-based communication channel. Communication messages may include any text, image, video, audio, or combination thereof provided by a user (using a client device). For instance, the user may provide a messaging communication that includes text as well as an image and a video within the messaging communication as message contents. In such a case, the text, image, and video would comprise the messaging communication or digital content object. Each message sent or posted to a group-based communication channel of the group-based communication system includes metadata comprising the following: a timestamp associated with post of the message, a sending user identifier, a message identifier, message contents, a group identifier, a group-based communication channel identifier, a thread identifier, and the like. Each of the foregoing identifiers may comprise ASCII text, a pointer, a memory address, and the like.

In accordance with the example shown in FIG. 1, the client devices 102-106 are configured to display the received messages in a contextually-relevant user interface available to the user of the client device. For example, messages transmitted from a first client device 102 as a part of a group-based communication channel are displayed in a user interface display on client devices 102-106 associated with other members of the group-based communication channel.

As described herein, the group-based communication system 118 can be “channel-based” such that users can communicate via one or more communication channels. A “group-based communication channel” can refer to a virtual communications environment or feed that can be configured to display messaging communications posted by channel members (e.g., validated users accessing the environment using client devices) that are viewable only to the members of the group. The format of the group-based communication channel may appear differently to different members of the group-based communication channel; however, the content of the group-based communication channel (i.e., messaging communications) may be displayed to each member of the group-based communication channel. For instance, in one example, a common set of group-based messaging communications will be displayed to each member of the respective group-based communication channel such that the content of the group-based communication channel (i.e., messaging communications) will not vary per member of the channel. However, in another example, a member may join a group-based communication channel and only be able to view subsequent group-based messaging communications (as opposed to historical group-based messaging communications). The group-based communication channels are generally topic-oriented, long-lasting channels as opposed to ad hoc ephemeral conversations in conventional messaging apps.

In some examples, a group-based communication channel can be private such that the group-based communication channel has restricted access and is not generally accessible and/or searchable by other members of the group-based communication system. For example, only those users or administrators who have knowledge of and permission to access (e.g., a group-based communication channel identifier for the private group-based communication channel is associated with their user profile after the user has been validated/authenticated) the private group-based communication channel may view content of the private group-based communication channel. In various examples, a private group-based communication channel may be associated with a group-based communication channel identifier.

In some examples, each group-based communication channel, which can be referred to as a “communication channel” or “channel” herein, can be associated with a group-based communication channel identifier. A group-based communication channel identifier can comprise one or more items of data by which a group-based communication channel may be uniquely identified. For example, a group-based communication channel identifier may comprise ASCII text, a pointer, a memory address, and the like.

In at least one example, a virtual communications environment or feed that is configured to display messaging communications posted by channel members (e.g., validated users accessing the environment using client devices) that are viewable only to the members of the group can be referred to as a “group-based communication channel interface.” The format of the group-based communication channel interface may appear differently to different members of the group-based communication channel; however, the content of the group-based communication channel interface (i.e., messaging communications) will be displayed to each member of the group-based communication channel. For instance, a common set of group-based messaging communications will be displayed to each member of the respective group-based communication channel such that the content of the group-based communication channel interface (i.e., messaging communications) will not vary per member of the group-based communication channel.

As discussed in greater detail herein, messages, other objects, and/or other data may be provided to application systems 112-116 to initiate one or more processing actions executable within the respective application systems. A processing action, in this context, can refer to an executable action performed by an application system of the application systems 112-116. A processing action may be embodied as a data generation process, a data manipulation process, and/or the like that is performed based at least in part on data included within a processing action execution data packet provided from the group-based communication system to the application system. As various examples, a processing action may be the creation of a calendar object (e.g., via a scheduling app), the creation of a “to-do” item (e.g., via a productivity app), the creation of a service ticket (e.g., via a service app), the creation of a bookmark (e.g., via a link compilation app), the creation of a file (e.g., via a document editing app), the initiation of a call (e.g., via a video conferencing app), and/or the like. In certain examples, processing actions associated with an application may be configured at least in part based on processing action data provided by a developer associated with the application.

In certain examples, processing actions may be embodied as one of a plurality of processing action types. The processing action type of a processing action may be one of the processing action characteristics by which the processing action may be defined. For example, processing actions may comprise global processing actions, channel processing actions, message processing actions, object processing actions, and/or the like. In at least one example, a global processing action can be defined by a developer user associated with the global processing action as not being dependent on a particular communication channel, message, object, and/or the like. Global processing actions may be requested, for example, via an application home interface or a group-based communication interface menu (e.g., a file menu associated with the group-based communication interface displayed via a client device). As a non-limiting example, a global processing action may be the generation of a task item that is personal to a user.

In certain examples, processing actions can be made available to client devices 102-106 on a group-basis (e.g., such that individual processing actions are available to every member of a particular group), on a communication channel basis (e.g., such that individual processing actions are available to every member of a particular communication channel), on an individual basis (e.g., such that individual processing actions are available to certain individual client devices 102-106), on a sending user identifier basis (e.g., such that individual processing actions are available only for certain messages transmitted by particular users, such that the message is associated with a particular sending user identifier), and/or the like. As an added limitation, certain processing actions may only be executable via client devices 102-106 that are directly authenticated with a particular application system configured to execute the processing action (as indicated by the dashed lines between the individual client devices 102-106 and example application system(s) 112-116).

The processing actions may be made available by the application system(s) 112-116 based on developer interaction with the group-based communication system 118 setting access limitations for the processing actions. Those processing actions may comprise one or more discrete functions provided by the application system. For example, a single function of the application system may be called via the processing actions, or a plurality of processing actions, collectively considered a workflow characterized by passing input and/or output between each of the plurality of functions, may define a processing action. In certain examples, a workflow may rely on one or more functions performed by the group-based communication system 118 to begin a workflow, to end a workflow, and/or between other functions of a workflow. For example, a workflow may comprise functions performed by one or more of the application systems 112-116 to generate an output passed back to the group-based communication system 118, that output causing the group-based communication system 118 to execute one or more additional functions, which may be utilized by one or more additional functions of one or more of the application systems 112-116. In some examples, such discrete functions, processing actions, or the like can be called “steps.”

In certain examples, a developer associated with an application system of the application systems 112-116 may provide user input to the group-based communication system identifying the availability of one or more processing actions and/or identifying the processing action type to thereby enable the group-based communication system 118 to determine how the processing action is to be made available to users. For example, user input may specify that a particular processing action is a message processing action, to be made available to users via message-specific menus.

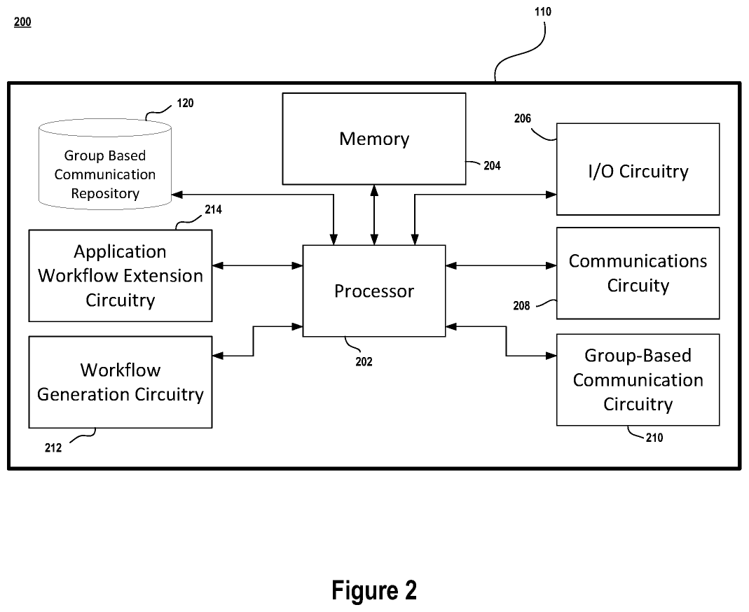

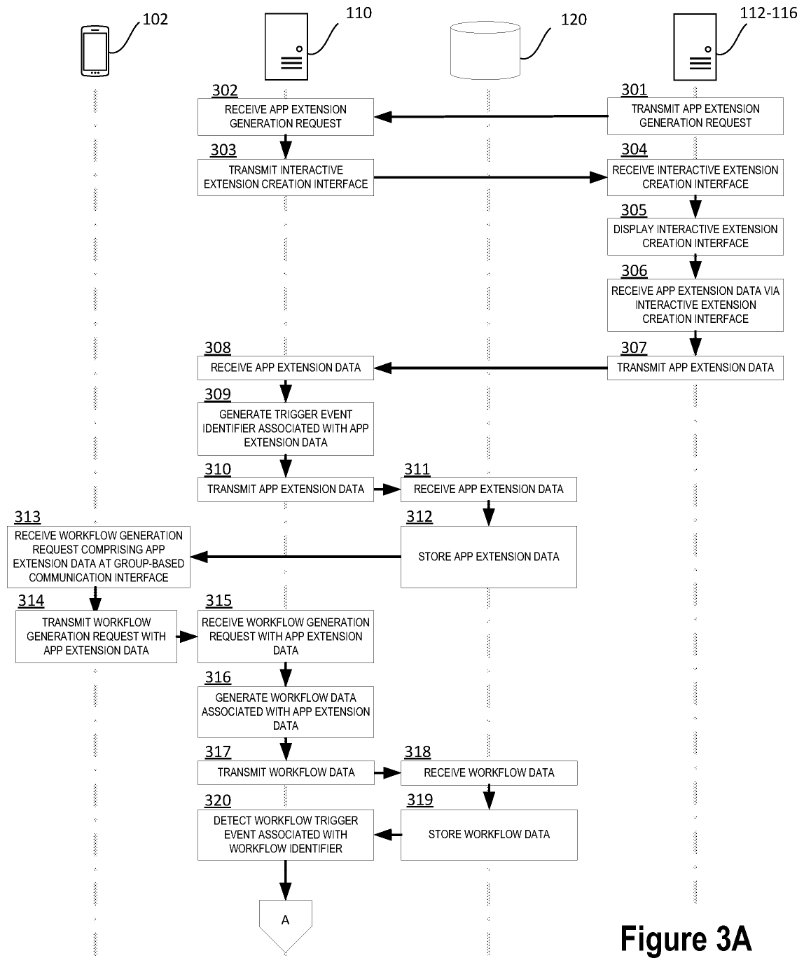

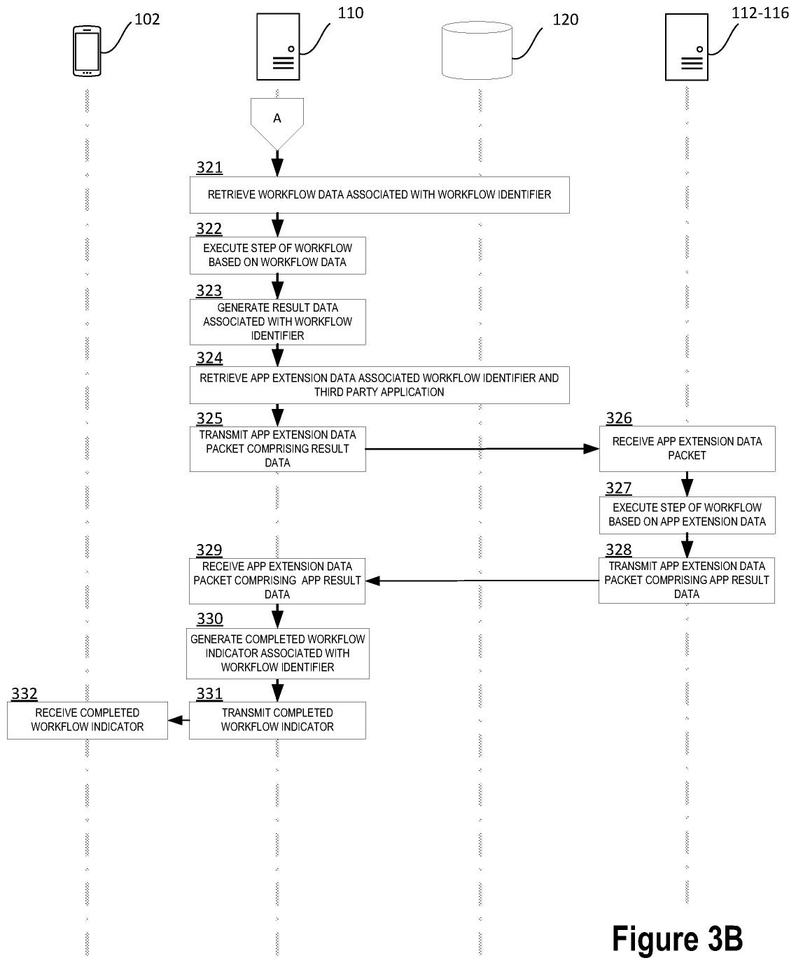

Each group-based communication server(s) 110 may be embodied by one or more computing systems, such as apparatus 200 shown in FIG. 2. The apparatus 200 may include processor 202, memory 204, input/output circuitry 206, communications circuitry 208, group-based communication circuitry 210, workflow generation circuitry 212, and application workflow extension circuitry 214. The apparatus 200 may be configured to execute the operations described herein with respect to FIGS. 3A-3C and 4-7. Although components 202-214 are described with respect to functional limitations, it should be understood that the particular implementations necessarily include the use of particular hardware. It should also be understood that certain of these components 202-214 may include similar or common hardware. For example, two sets of circuitries may both leverage use of the same processor, network interface, storage medium, or the like to perform their associated functions, such that duplicate hardware is not required for each set of circuitries.

In some examples, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus 200 to carry out various functions in accordance with example examples of the present invention.

The processor 202 may be embodied in a number of different ways and may, for example, include one or more processing devices configured to perform independently. In some preferred and non-limiting examples, the processor 202 may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In some preferred and non-limiting examples, the processor 202 may be configured to execute instructions stored in the memory 204 or otherwise accessible to the processor 202. In some preferred and non-limiting examples, the processor 202 may be configured to execute hard-coded functionalities. As such, whether configured by hardware or software methods, or by a combination thereof, the processor 202 may represent an entity (e.g., physically embodied in circuitry) capable of performing operations according to an example of the present invention while configured accordingly. Alternatively, as another example, when the processor 202 is embodied as an executor of software instructions, the instructions may specifically configure the processor 202 to perform the algorithms and/or operations described herein when the instructions are executed.

As just one example, the processor 202 may be configured to maintain one or more communication channels connecting a plurality of client devices 102-106 to enable message sharing therebetween. The processor 202 ensures that messages intended for exchange between the client devices 102-106 within the particular communication channel are properly disseminated to those client devices 102-106 for display within respective display windows provided via the client devices 102-106.

Moreover, the processor 202 may be configured to synchronize messages exchanged on a particular communication channel with a database for storage and/or indexing of messages therein. In certain examples, the processor 202 may provide stored and/or indexed messages for dissemination to client devices 102-106.

In some examples, the apparatus 200 may include input/output circuitry 206 that may, in turn, be in communication with processor 202 to provide output to the user and, in some examples, to receive an indication of a user input. The input/output circuitry 206 may comprise a user interface and may include a display, and may comprise a web user interface, a mobile application, a client device, a kiosk, or the like. In some examples, the input/output circuitry 206 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The communication circuitry 208 may be any means such as a device or circuitry embodied in either hardware or a combination of hardware and software that is configured to receive and/or transmit data from/to a network and/or any other device, circuitry, or module in communication with the apparatus 200. In this regard, the communication circuitry 208 may include, for example, a network interface for enabling communications with a wired or wireless communication network. For example, the communication circuitry 208 may include one or more network interface cards, antennae, buses, switches, routers, modems, and supporting hardware and/or software, or any other device suitable for enabling communications via a network. Additionally or alternatively, the communication circuitry 208 may include the circuitry for interacting with the antenna/antennae to cause transmission of signals via the antenna/antennae or to handle receipt of signals received via the antenna/antennae.

Group-based communication circuitry 210 includes hardware configured to support a group-based communication system 118. The group-based communication circuitry 210 may utilize processing circuitry, such as the processor 202, to perform these actions. The group-based communication circuitry 210 may send and/or receive data from group-based communication repository 120. In some implementations, the sent and/or received data may be of digital content objects organized among a plurality of group-based communication channels. It should also be appreciated that, in some examples, the group-based communication circuitry 210 may include a separate processor, specially configured field programmable gate array (FPGA), or application specific interface circuit (ASIC). The group-based communication circuitry 210 may be implemented using hardware components of the apparatus 200 configured by either hardware or software for implementing these planned functions.

The workflow generation circuitry 212 may be any means such as a device or circuitry embodied in either hardware or a combination of hardware and software that is configured to generate a workflow generation interface to be rendered within the group-based communication interface. Further, in various examples, the workflow generation circuitry 212 may be configured to initialize a workflow within the group-based communication system based on the receipt of a workflow generation interface element. The workflow generation circuitry 212 may utilize processing circuitry, such as the processor 202, to perform these actions. The workflow generation circuitry 212 may send and/or receive data from group-based communication repository 120. In some implementations, the sent and/or received data may be workflow data, application extension data, and/or other data of a group-based communication data corpus. It should also be appreciated that, in some examples, the workflow generation circuitry 212 may include a separate processor, specially configured field programmable gate array (FPGA), or application specific interface circuit (ASIC).

The application workflow extension circuitry 214 may be any means such as a device or circuitry embodied in either hardware or a combination of hardware and software that is configured to generate an interactive extension creation interface within a group-based communication interface. Further, in various examples, the application workflow extension circuitry 214 may be configured to generate an application extension data packet to be transmitted to an application. Further, in various examples, the application workflow extension circuitry 214 may be configured to generate an application extension interface to be transmitted to a client device for display within the group-based communication interface displayed thereon. The application workflow extension circuitry 214 may utilize processing circuitry, such as the processor 202, to perform these actions. The application workflow extension circuitry 214 may send and/or receive data from group-based communication repository 120. In some implementations, the sent and/or received data may be workflow data, application extension data, and/or other data of a group-based communication data corpus. It should also be appreciated that, in some examples, the application workflow extension circuitry 214 may include a separate processor, specially configured field programmable gate array (FPGA), or application specific interface circuit (ASIC).

It is also noted that all or some of the information discussed herein can be based on data that is received, generated and/or maintained by one or more components of apparatus 200. In some examples, one or more application systems (such as a remote cloud computing and/or data storage system) may also be leveraged to provide at least some of the functionality discussed herein.

The term “circuitry” should be understood broadly to include hardware and, in some examples, software for configuring the hardware. With respect to components of each apparatus 200, the term “circuitry” as used herein should therefore be understood to include particular hardware configured to perform the functions associated with the particular circuitry as described herein. For example, in some examples, “circuitry” may include processing circuitry, storage media, network interfaces, input/output devices, and the like. In some examples, other elements of the apparatus 200 may provide or supplement the functionality of particular circuitry. For example, the processor 202 may provide processing functionality, the memory 204 may provide storage functionality, the communication circuitry 208 may provide network interface functionality, and the like.

As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

As described above and as will be appreciated based on this disclosure, examples of the present invention may be configured as methods, mobile devices, backend network devices, and the like. Accordingly, examples may comprise various means including entirely of hardware or any combination of software and hardware. Furthermore, examples may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

Moreover, various examples of the group-based communication system 118 may comprise one or more databases configured for storing and/or indexing messages exchanged within various group-based communication channels. In some examples, such databases can be associated with the group-based communication repository 120, described above.

As noted above, systems and methods for providing an interactive extension creation interface and incorporating an external application functionality in a workflow generated within a group-based communication system according to various examples are discussed herein.

FIGS. 3A-3B illustrate a lane diagram showing functionality of various components associated with an example workflow extension in accordance with various examples. As shown at Blocks 301 and 302, in various examples, an application extension generation request may be transmitted from a developer client device associated with an application system(s) 112-116 and received by the group-based communication server(s) 110. In various examples, the application extension generation request may comprise a collection of data transmitted by a developer client device associated with an application system(s) 112-116 to the group-based communication server(s) 110 as a result of a developer associated with an application system(s) 112-116 indicating a desire to generate an application extension associated with the application system(s) 112-116. For example, an application extension generation request may be transmitted to the group-based communication server(s) 110 in response to the receipt of a selection of an element associated with an application generation request at a group-based communication interface displayed at the developer client device. As described herein, an application extension may facilitate the implementation of a functionality of an application associated therewith in association with the group-based communication system 118. For example, in various examples, an application extension associated with an application system(s) 112-116 may enable the incorporation of at least one functionality of the application system(s) 112-116 into the group-based communication system 118 such that the functionality is executable as part of a workflow generated by the group-based communication system 118. That is, an application extension can enable the incorporation of a step, executable by the application system(s) 112-116, into a workflow, as described herein.

An application extension generation request may be associated with a user identifier associated with the developer and/or a client device associated therewith, and an application identifier associated with an application system(s) 112-116. For example, an application extension generation request may be transmitted from the developer client device associated with the application system(s) 112-116 upon receiving a selection of an element associated with the interactive extension creation interface at the developer client device via the group-based communication interface. Alternatively, in various examples, an application extension generation request may be transmitted from the developer client device associated with the application system(s) 112-116 to the application system(s) 112-116 based on developer interaction with an interface associated with the application system(s) 112-116. In such a circumstance, such as, for example, wherein the application system(s) 112-116 receives a selection of an element associated with the interactive extension creation interface at the developer client device via an application-based interface, the application system(s) 112-116 may transmit at least a portion of the data associated with the request to the group-based communication server(s) 110.

Upon receiving the application extension generation request from the developer client device associated with the application system(s) 112-116, as shown at Blocks 303 and 304, the group-based communication server(s) 110 may transmit an interactive extension creation interface to the client device associated with the application system(s) 112-116 for rendering at a display device associated therewith. As described herein, the interactive extension creation interface transmitted to the developer client device in response to receiving an application extension generation request may be configured to receive user input from the developer associated with the application system(s) 112-116 with respect to the desired configuration of the application extension. The interactive extension creation interface may comprise a pane at which the developer may input and/or generate application extension data so as to define the functionality and configuration of the application extension within the group-based communication system 118. For the purpose of this discussion, a pane can comprise a defined area within a group-based communication interface configured for rendering various data as determined and described herein. A pane may be embodied as a container, which may be populated with data received from an external data source. As shown at Block 305, the interactive extension creation interface may be displayed at the developer client device associated with the application system(s) 112-116 within a group-based communication interface.

As shown at Block 306, the developer client device associated with the application system(s) 112-116 may receive application extension data defined by the developer user input at the interactive extension creation interface. In various examples, application extension data may comprise data that may at least partially define a developer-constructed custom application workflow step associated with the application system(s) 112-116, which may be selected by a user to comprise a step of a workflow generated by the user in the group-based communication system 118. For example, application extension data may comprise one or more executable instructions configured at least in part by a developer associated with an application system(s) 112-116 that defines the functionality of an application workflow step.

Further, the application extension data received by the developer client device may comprise application extension parameters. In at least one example, an application extension parameter can comprise data that describes and/or defines at least a part of the executable instructions associated with an application workflow extension that may enable the execution of the corresponding application workflow step. In certain examples, an application extension parameter may be represented as an input variable associated with the application extension that is required to facilitate the execution of the application workflow step based at least in part on corresponding user and/or group-based communication system input. In certain examples, an application extension parameter may be designated as either required or optional in relation to the execution of the processing action.

In at least one example, application extension parameters can define one or more input variables associated with the application extension and can be configured to facilitate the execution of the application workflow step based at least in part on corresponding user input received by the group-based communication server(s) 110 at an application extension interface and/or a previous step of the work flow (e.g., results data). As discussed herein, the developer client device associated with the application system(s) 112-116 may receive, via the interactive extension creation interface, application extension data comprising application extension interface data, which, as described herein, defines the configuration of an application extension interface associated with the application extension. In various examples, application extension data may further comprise an application extension name, application extension description, application extension callback identifier, such as, for example, a callback URL associated specifically with the application extension (e.g., an application extension identifier), and application extension trigger data. In various examples, application extension trigger data may define one or more trigger events that may operably correspond with the functionality of the application extension such that the application workflow step defined by the application extension data may be available to be executed upon the occurrence of the one or more trigger events. In some examples, trigger events can be associated with trigger event identifiers, which can include one or more items of data by which a trigger event may be uniquely identified. For example, a trigger event identifier may comprise ASCII text, a pointer, a memory address, and the like.

In various examples, at least a portion of application extension data may be input and/or generated as user input provided by the developer. For example, in various examples, application extension data may comprise data that may at least partially define an application workflow template, which may comprise an example workflow blueprint detailing each of the workflow steps of an example workflow, wherein the example workflow comprises at least one application workflow step that is executable by the application system(s) 112-116. In various examples, an application workflow template may be generated by the developer to address to a particular use case of the application workflow step that is known to the developer. An application workflow template developed by the developer via the interactive extension creation interface may be presented to a user who has installed the application system(s) 112-116, as described herein, within the group-based communication interface. For example, each workflow defined by an application workflow template may be associated with an application workflow identifier.

In at least one example, the application extension interface, which may be configured to display at least a portion of the application extension data, such as, for example, an application extension name and/or one or more application extension parameters, within a group-based communication interface, may define a customizable block configuration that reflects the developer's desired configuration of one or more user engagement blocks arranged within the application extension interface. In at least one example, a user engagement block can comprise a designated section or area within a group-based communication interface that can be used for displaying at least a portion of application extension data. In certain examples, a user engagement block may be configured to reflect execution of one or more user engagement pane instructions corresponding to one or more functionalities of an application.

In various examples, at least a portion of the application extension data may comprise block data associated with one or more user engagement blocks configured to reflect one or more application extension parameters corresponding to one or more functionalities of an application. Block data can comprise any data, data set, or data packet that is sent from an application and may be used by the group-based communication server(s) 110 for rendering an application extension interface within a group-based communication interface associated with a client device. For example, the block data may comprise multiple block arrays, wherein each block array is associated with a respective block to be rendered for display within the application extension interface. A block array may comprise a plurality of block element values—electronically generated values associated with a respective attribute of a block element that may be used to define how the block element may be displayed within a user engagement block so as to reflect the block element configuration defined by a developer—associated with a user engagement block type.

In various examples, user engagement blocks may be configured such that the developer may selectively configure the input type and allowable input values at each of the one or more user engagement blocks based at least in part on the data needed by the application system(s) 112-116 to execute the application workflow step associated with the workflow. For example, in various examples, each user engagement block may be configured to display block data comprising one or more block arrays, each block array being respectively associated with a user engagement block. As described herein, a block array may comprise a plurality of block element values associated with a particular user engagement block type. In various examples, each user engagement block may comprise a user engagement block type, selected by the developer from a plurality of user engagement block types available for rendering within the group-based communication interface. As described herein, the user engagement block type may correspond to a developer's desired input type at that particular block. For example, the plurality of user engagement block types may comprise one or more of a text block type, a thumbnail block type, a divider block type, an image block type, a video block type, a meta block type, an action block type, a poll block type, a file block type, a call block type, a combination thereof, and/or the like.

As shown at Blocks 307 and 308, the group-based communication server(s) 110 may transmit the application extension data received via the interactive extension creation interface to the group-based communication server(s) 110. As discussed herein, the application extension data received by the group-based communication server(s) 110 may comprise one or more application extension parameters, application extension interface data, an application extension name, application extension description, and an application extension callback identifier. Further, in various examples, the application extension data received by the group-based communication server(s) 110 may comprise application extension trigger data. The group-based communication server(s) 110 may generate a trigger event identifier associated with each of the one or more trigger events configured to initiate the execution of the application workflow step, as defined by the developer, as shown at Block 309. In various examples, a trigger event associated with a workflow and/or application workflow step may be defined by a developer associated with an application system(s) 112-116 such that it may occur either within the group-based communication system 118 or within an external resource associated with the application system(s) 112-116. The group-based communication server(s) 110 may further associate the trigger event identifier with the application extension data and with an application identifier associated with the application system(s) 112-116. Although the generation of a trigger event identifier is described herein with respect to Block 309, it should be understood that the group-based communication system may additionally and/or alternatively generate one or more trigger event identifiers associated with an application workflow and/or an application workflow step after receiving a workflow generation request associated with the application extension data associated with the application system(s) 112-116.

Once the application extension data is associated with a trigger event identifier, the group-based communication server(s) 110 transmits the application extension data associated with the application system(s) 112-116 to the group-based communication repository 120 for storage as indicated at Blocks 310, 311, and 312. In some examples, at Block 312, the application extension data may be stored as steps associated with the corresponding application in a step repository that stores steps and the corresponding applications. In some examples, steps that are stored in the repository may later be accessed for use in other workflows. In various examples, the application extension data generated based on the developer input at the interactive extension creation interface may be stored in one or more searchable and/or transferable data formats, such as for example, JavaScript Object Notation (JSON). In various examples, once the application extension data associated with application system(s) 112-116 is stored within the group-based communication repository 120, the application extension may be bundled with the application system(s) 112-116 within the group-based communication system 118 and an application workflow step corresponding to the application extension may be available to a user and/or client device 102 that has installed the application system(s) 112-116 for inclusion in a workflow generated within the group-based communication system 118 by the user.

As shown at Block 313, a client device 102 may receive user input at a group-based communication interface embodied as a workflow generation request. In various examples, the user input received by the client device may comprise a selection of a workflow generation element displayed at the client device 102 within a group-based communication interface, which may indicate the desire of the user associated with a user identifier associated with the client device 102 to generate a workflow within the group-based communication system 118. In various examples, the workflow generation element may be disposed within an interactive workflow configuration interface rendered within the group-based communication interface at the client device 102. As described herein, an interactive workflow configuration interface may facilitate the generation of a user-defined workflow within the group-based communication system 118. In various examples, the interactive workflow configuration interface may display one or more workflow steps available to a user for inclusion in a user-defined workflow. One or more workflow steps may be selected and sequenced according to user input at the interactive workflow configuration interface in order to generate the user-defined workflow. In various examples, wherein the group-based communication server(s) 110 determines that a user and/or a client device 102 associated therewith has installed the application system(s) 112-116, an application workflow step element associated with an application workflow step corresponding to an application extension associated with the application system(s) 112-116 may be rendered within the interactive workflow configuration interface. In various examples, the client device 102 may receive a selection of the application workflow step element, indicating a desire of the user associated with the client device 102 to incorporate the application workflow step into a user-defined workflow generated by the user. In such a circumstance, the group-based communication server(s) 110 may associate the workflow generation request with the application extension data that defines the application workflow step. As shown at Blocks 314 and 315, the client device 102 may transmit the workflow generation request associated with the application extension data to the group-based communication server(s) 110.

In some examples, the interactive workflow configuration interface may present indications of selectable steps that have been previously created and, in some examples, can be stored in a repository (e.g., library), as described above. A user may select previously created steps to be incorporated into the workflow without having to create the step from scratch. In some examples, the interactive workflow configuration interface allows the user to select and add one or more steps as part of the workflow. In some examples, a user can create a step prior to or during workflow building. That is, in some examples, a workflow step may be created by a user or may be selected from a repository comprising preexisting steps (e.g., provided by third-parties and/or the group-based communication system 118) that are supported by the group-based communication system 118 for incorporation into a workflow. For example, in a workflow that utilizes a spreadsheet application, the interactive workflow configuration interface may include user interface elements to guide the user to set up workflow extensions or allow the user to choose from preexisting steps such as adding a row or removing a row from the spreadsheet that were previously created and stored to a step repository. The user may choose to incorporate any number of steps including custom steps, preexisting steps, or native steps. Example user interfaces and workflows are described below.

As shown at Block 316, the group-based communication server may generate workflow data. As described herein, workflow data may comprise data that may at least partially define a user-defined custom workflow generated within the group-based communication system 118. In various examples, the user-defined custom workflow may comprise one or more workflow steps configured in sequence that may be collectively configured to accomplish a task upon the execution of each workflow step. For example, a workflow step may comprise a processing action, as described herein. In various examples, a workflow step may comprise an application workflow step that is executable by an application system(s) 112-116. The application workflow step may correspond to at least a portion of a functionality of the application system(s) 112-116. In various examples, workflow data associated with a workflow may comprise a workflow identifier, a workflow creator identifier, a workflow trigger event identifier, and one or more executable instructions which may facilitate the execution of the workflow. The workflow trigger event identifier may be associated with each of the one or more workflow trigger events, which, as described herein, may comprise an action, incident, collection of steps, or processes executed by the client device 102, the group-based communication server(s) 110, and/or the application system(s) 112-116 that initializes the execution of the workflow, as defined by the workflow creator. As described herein, in various examples, a trigger event associated with a workflow may be defined by the developer such that it may occur either within the group-based communication system 118 or within an external resource associated with the application system(s) 112-116 associated with the developer. In various examples wherein a workflow is defined at least in part by an application workflow step associated with the application system(s) 112-116, the workflow data may be associated with application data associated with the application system(s) 112-116, such as, for example, application extension data corresponding to the application workflow step.

Upon generating the workflow data associated with the application system(s) 112-116, the group-based communication server(s) 110 may transmit the workflow data associated with the application system(s) 112-116 (e.g., the application identifier) to the group-based communication repository 120 for storage, as shown at Blocks 317, 318, and 319. As shown at Block 320, the group-based communication server(s) 110 may detect a workflow trigger event associated with a workflow trigger event identifier associated with the workflow identifier of the user-defined workflow generated by the user associated with client device 102. A workflow trigger event may be detectable by the group-based communication server(s) 110 and may be associated with one or more client devices 102. In various examples, trigger events may be pre-defined (e.g., button clicks, slash commands, etc.) or may be learned by the group-based communication system 118 over time using machine learning models or other similar techniques. As described herein, a workflow trigger event may be based at least in part on user engagement with a group-based communication interface at the client device 102. For example, in various examples, the group-based communication server(s) 110 may render a workflow element associated with the user-defined workflow within the group-based communication interface displayed at the client device 102 associated with the user. Based at least in part on the configuration of the workflow as defined by the user (e.g., the workflow creator), selection of said workflow element associated with the workflow may comprise a workflow trigger event for said workflow. Further, although described herein with respect to an example trigger event that is detected by the group-based communication system 118, in various examples the trigger event associated with a workflow may be defined by a developer associated with an application system(s) 112-116 to occur within an external resource associated with the application 121-116 such that it may be detectable by the application system(s) 112-116.

Upon the detection of a workflow trigger event associated with the workflow identifier, the process proceeds to Block 321 of FIG. 3A, at which the group-based communication server(s) 110 may retrieve, from the group-based communication repository 120, the workflow data associated with the workflow identifier. In various examples, the workflow data retrieved from the group-based communication repository 120 by the group-based communication server(s) 110 may comprise the same workflow data generated by the group-based communication server(s) 110 from the application system(s) 112-116 at Block 316. Further, in various examples, the workflow data retrieved from the group-based communication repository 120 by the group-based communication server(s) 110 may comprise workflow data that has been modified (e.g., updated) by the workflow creator—via an interactive workflow configuration interface, as described herein—subsequent to the generation of the workflow data by the group-based communication server(s) 110 at Block 316. In such circumstance, the group-based communication server(s) 110 may provide the modified workflow data to the group-based communication repository 120 to replace and/or supplement the preexisting workflow data, such that the workflow data retrieved from the group-based communication repository 120 by the group-based communication server(s) 110, as shown at Block 321, may comprise said modified workflow data.

As shown at Block 322, based at least in part on the workflow data associated with the user-defined workflow, the group-based communication server(s) 110 may execute a workflow step of the example workflow. In various examples, as described herein, the execution of a workflow step may comprise performing an algorithm and/or operation (e.g., a processing action) by executing one or more programmed instructions associated therewith. In various examples, the group-based communication server(s) 110 may produce one or more outputs resulting from the execution of a workflow step. In such a circumstance, said outputs may define at least a portion of results data, which may be generated by the group-based communication server(s) 110, as shown at Block 323. For example, the results data may be associated with the workflow step and the workflow identifier associated therewith. In various examples, the results data generated by the group-based communication server(s) 110 may comprise the outputs of the workflow step, the inputs to the workflow step (e.g., a group-based communication message, a group-based communication object, an identifier, and/or the like), workflow step timestamp data, and/or a completed workflow step indicator. As used herein, the term indicator can refer to one or more items of data associated with one or more elements of a group-based communication system 118 that indicates that a particular condition corresponding to the one or more elements associated therewith is present. In various examples, an indicator may comprise a textual or graphical statement generated as a representation that a given condition is present. For example, an indicator may be a data structure comprising a flag, or a record of a data structure whereby a logical “1” indicates that given condition is present and a logical “0” indicates that the given condition is not present. For example, in various examples, an indicator may be a previously unvisited indicator, a previously visited indicator, an unread message indicator, or an abandoned page indicator, as determined and described herein.

In various examples, an output of a workflow step may comprise data associated with the workflow that is produced based at least in part on user input received by the group-based communication server(s) 110 at the group-based communication interface during the execution of the workflow step. In various examples at least a portion of the results data may correspond to a trigger event of a workflow step similarly associated with the workflow identifier.

In various examples, as described herein, the group-based communication server may detect a trigger event associated with a trigger event identifier generated as discussed with respect to Block 309. As shown at Block 324, the group-based communication server(s) 110 may retrieve, from the group-based communication repository 120, the application extension data associated with the workflow identifier and the application system(s) 112-116. In various examples, the application extension data retrieved from the group-based communication repository 120 by the group-based communication server(s) 110 may comprise application extension data that has been modified (e.g., updated) by the developer associated with the application system(s) 112-116 subsequent to the receipt of the application extension data by the group-based communication server(s) 110 at Block 308. In such circumstance, the group-based communication server(s) 110 may provide the modified application extension data to the group-based communication repository 120 to replace and/or supplement the preexisting application extension data, such that the application extension data retrieved from the group-based communication repository 120 by the group-based communication server(s) 110, as shown at Block 324, may comprise said modified application extension data.

In various examples, based at least in part on the developer user input received at the interactive extension creation interface rendered within the group-based communication interface at the developer client device, as discussed herein with respect to Block 306, the group-based communication server(s) 110 may generate an application extension data string corresponding to at least a portion of application extension data stored in the group-based communication repository. The group-based communication server(s) 110 may generate an application extension data packet comprising the application extension data string to be transmitted to the application system(s) 112-116. In various examples, the application extension data packet be selectively configured by the group-based communication server(s) 110 as a transferable function signature so as to facilitate the execution of the application workflow step by the application system(s) 112-116. The elements of the transferable function signature may be defined at least in part based on the aforementioned developer input at the interactive extension creation interface. The application extension data packet may further comprise various data required by the application system(s) 112-116 to execute the corresponding application workflow step. For example, the application extension data packet may comprise a user identifier associated with the client device 102, the workflow identifier, the application extension data string, at least a portion of the results data associated with the workflow identifier, the application extension callback identifier, and the application extension callback URL. In various examples, the group-based communication server(s) 110 may configure the application extension data packet such that it may include a portion of the results data that corresponds to one or more of the application extension parameters associated with the application extension.

In various examples, the group-based communication server(s) 110 may detect that one or more of the application extension parameters has not been determined based on the data within the generated application extension data packet. In such a circumstance, the group-based communication server(s) 110 may be configured to transmit an application extension interface associated with the application extension to the client device 102 associated with the workflow trigger event. As described herein, the application extension interface may be configured based on developer input to the interactive extension creation interface. In various examples, the application extension interface may comprise one or more interactive dialogs configured to receive user input at the client device 102, the user input corresponding to one or more of the application extension parameters. In at least one example, an interactive dialog can be a user interface element configured to accept user input (e.g., as a selection of one or more of a plurality of available options, as freeform input, and/or the like). The interactive dialog may be presented as a pop-up or an overlaid display element displayed visually over another portion of a user interface, or the dialog may be presented as a portion of a larger user interface element. In certain examples, an interactive dialog may comprise one or more interactive dialog inputs.

Upon generation of the application extension data packet, the group-based communication server(s) 110 provides the data packet via a proxy endpoint to the application system(s) 112-116 as shown at Blocks 325 and 326. For example, the group-based communication server(s) 110 may provide the application extension data packet using first URL, which may be, for example, a general application URL that associated with the application system(s) 112-116, but is not specific to—or indicative of—the application workflow step. In various examples a proxy endpoint may provide an API for passing the application extension data packet from the group-based communication server(s) 110 to the application system(s) 112-116, thereby enabling the application system(s) 112-116 to consume the elements of function signature within the data packet while executing the application workflow step. That is, a proxy endpoint can be a data transfer interface, for example an Application Program Interface (API) between unconnected computing systems via a network. The proxy endpoint may be accessible over the network via a URL. For example, a proxy endpoint may enable data transfer of a data packet (comprising routing data and/or payload data) from a group-based communication system 118 to an application system of the application systems 112-116 associated with an application published and usable via the group-based communication system. In various examples, the proxy endpoint is defined at least in part by a URL accessible to the application system, wherein the URL may be utilized to direct the application system to a particular dataset (e.g., one or more data packets). As discussed herein, data packets provided to the application system via the proxy endpoint may comprise data formatted to enable usage by the application system to perform a desired processing action. The proxy endpoint enables transfer of the data packet to the application system while maintaining the necessary formatting of the data packet to enable the application system to use the included data. Moreover, in certain examples the proxy endpoint enable real-time transmission of data to the application system (e.g., via push-based message transmission). In other examples, the proxy endpoint may be configured to enable the application system to pull data from the group-based communication system (e.g., upon the occurrence of a trigger event acting to inform the application system of the presence of data that is ready for transmission).

As described herein, the function signature and the data by which it is defined are included within the application extension data packet in a format configured at least in part based on the developer input to the interactive extension creation interface, so as to ensure that the application system(s) 112-116 can execute the application workflow step. The application system(s) 112-116 may execute the application workflow step as identified in the application extension data string, as shown at Block 327. In various examples, the application system(s) 112-116 may execute the application workflow step based at least in part on the results data generated by the group-based communication server(s) 110 during the execution of previous workflow steps associated with the workflow identifier.

As shown at Blocks 328-329, upon executing the application workflow step defined by the application extension data within the application extension data packet, application system(s) 112-116 transmits the application output data (e.g., resulting from the function signature) to the group-based communication server(s) 110 using the application extension callback URL defined within the application extension data. In various examples, the application extension callback URL may comprise a second URL distinct from the aforementioned general application URL through which the application extension data packet was transmitted from the group-based communication server(s) 110 to the application system(s) 112-116. The application extension callback URL may be associated with the application extension data, specifically, such that the group-based communication server may associate the application output data received via the application extension callback URL with the workflow identifier. In various examples, the application system(s) 112-116 may be configured to transmit additional data associated with the application workflow step, such as, for example, the user identifier associated with the client device 102, the workflow identifier, and/or the like, to the group-based communication server(s) 110 via the application extension callback URL.

As shown at Block 330, upon determining that each of the workflow steps of the workflow has been executed, the group-based communication server(s) 110 may generate a completed workflow indicator associated with the workflow identifier. In various examples, a completed workflow indicator may comprise data associated with a workflow identifier, a user identifier, and/or a client device identifier that indicates that each of the workflow steps of a user-defined workflow have been completed. In various examples, the completed workflow indicator may comprise a textual or graphical statement generated as a representation that the selected workflow has been completed in its entirety. As shown at Blocks 331 and 332, the group-based communication server(s) 110 provides the completed workflow indicator to the client device 102. In various examples, based at least in part on the workflow data associated with the workflow and the user-defined configuration thereof, the group-based communication server(s) 110 may further transfer workflow output data to the client device 102.

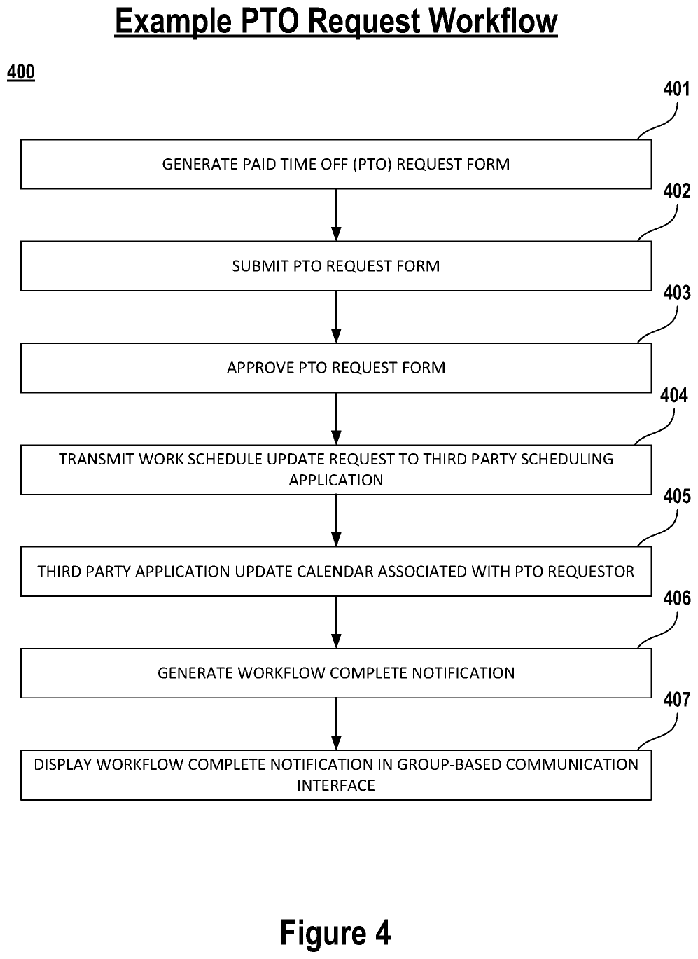

FIG. 4 illustrates example steps for executing an example workflow 400 associated with a group-based communication system. As described herein, a workflow may comprise an orchestrated series of operations that may be executed to accomplish a particular task. A workflow may comprise one or more workflow steps, each corresponding to a distinct action or operation that may be individually executed in sequence. In various examples, workflow steps may be deliberately ordered such that a step requiring a particular parameter in order to be executed may be initialized subsequent to the execution of an operation which produces that parameter as an output.

As illustrated, the example workflow 400 is directed to the submission by of a PTO request in a group-based communication system 118, wherein Blocks 401-407 each define a respective workflow step. However, it should be understood that workflows may be provided for accomplishing any of a variety of tasks. Blocks 401-407 define the various operations of the workflow 400, beginning with a user generating and submitting a PTO request form for approval and ending with the availability calendar associated with the user being updated to reflect one or more approved PTO days. In various examples, a workflow step may be executed by the group-based communication server(s) 110. Alternatively, a workflow step may be executed by an external application installed within the group-based communication system 118. As described herein, the external application may utilize an application extension to incorporate the functionality of the application into the group-based communication system 118 and facilitate the communication and transfer of data associated with a workflow between the group-based communication server(s) 110 and the external application. For example, as illustrated in FIG. 4, an application extension may be utilized to facilitate the execution of Block 405 by the third-party application.

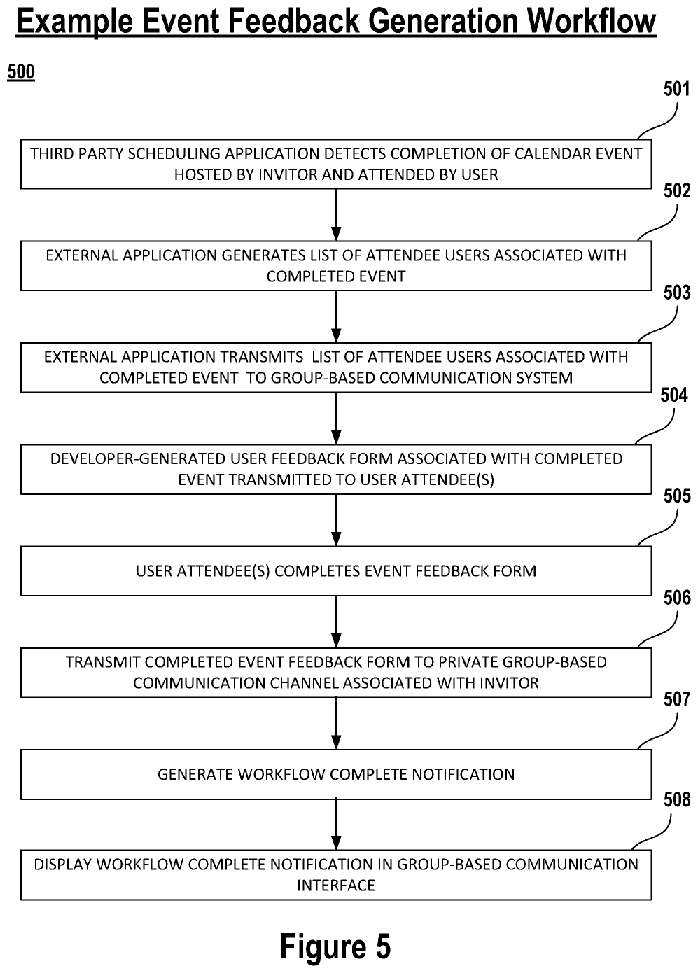

FIG. 5 illustrates example steps for executing an example workflow 500 associated with a group-based communication system. As described herein, a workflow may be initialized by either a group-based communication system 118 or an external application system(s) 112-116, based at least in part on application extension data generated by the input received from the developer associated with the application system(s) 112-116.

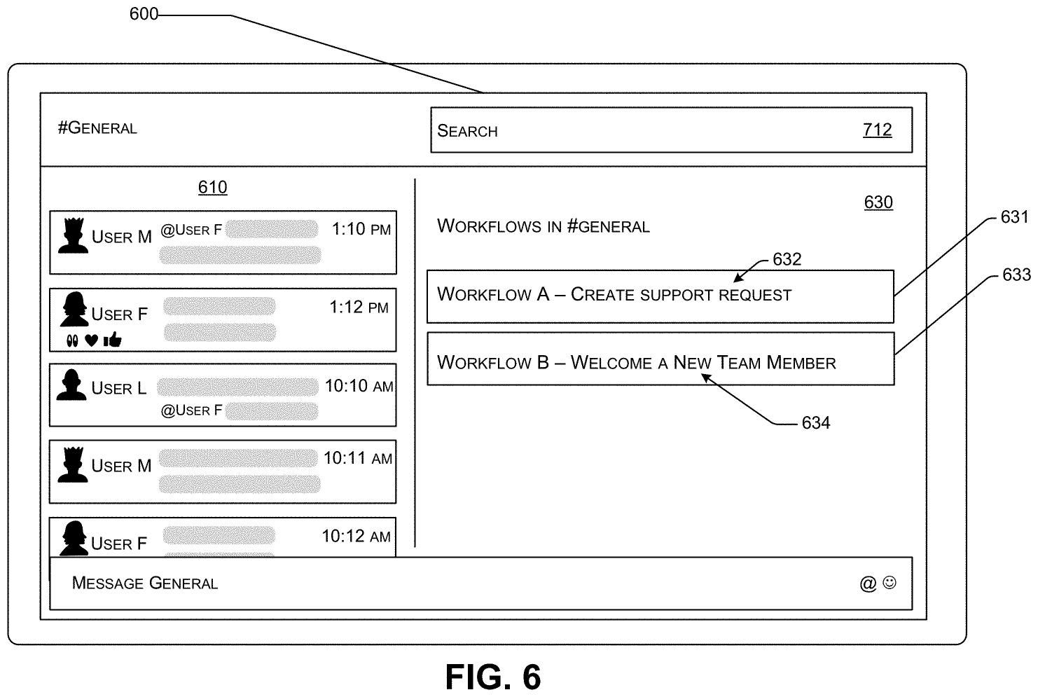

As illustrated, the example workflow 500 is directed to the generation of attendee feedback directed to a completed event, wherein Blocks 501-508 each define a respective workflow step. Each of blocks 501-508 may be a custom workflow step that is defined by the user creating the workflow or added to the workflow by adding the workflow step from a repository of previously created steps through the user interface described in FIG. 6. As shown, an external application detects a trigger event associated with the example workflow 500 and initializes the workflow. Blocks 501-508 define the various operations of the workflow 500, beginning with the third-party scheduling application detecting the completion of a scheduled event on the calendar of a user associated with the group-based communication system and ending with the event feedback form completed by the user attendee being transmitted to a private group-based communication channel associated with the user identifier associated with the event host (e.g., event inviter). In various examples, a workflow step may be executed by the group-based communication server(s) 110. Alternatively, a workflow step may be executed by an external application installed within the group-based communication system 118. As described herein, the external application may utilize an application extension to incorporate the functionality of the application into the group-based communication system 118 and facilitate the communication and transfer of data associated with a workflow between the group-based communication server(s) 110 and the external application. For example, an application extension may be utilized to facilitate the execution of Blocks 501-503 by the third-party application, as illustrated in FIG. 5.

FIG. 6 illustrates an example group-based communication interface 600 having a menu interface 630 configured to render a selectable workflow element associated with a user-generated workflow. As illustrated, the group-based communication interface 600 may comprise a group-based communication channel interface configured to display group-based communication messages posted by one or more users in a channel messaging pane 610 rendered within the group-based communication channel interface. Further, the group-based communication server(s) 110 may render a menu interface 630 within the group-based communication interface 600 in response to, for example, receiving a user selection of a workflow builder affordance from within the interface 600. In various examples, the group-based communication server may render one or more selectable workflow elements 631 associated with one or more executable workflows. The group-based communication server(s) 110 may be configured to initialize the workflow associated with the selectable workflow element 631 upon receiving a selection of the selectable workflow elements 631 from a client device. Further, the group-based communication server(s) 110 may render various workflow data 632 associated with the workflow identifier associated with the selectable workflow element 631 (e.g., the workflow name, description, external application associated therewith, and/or the like) within the menu interface 630. In some examples, if multiple workflows are associated with the communication channel and/or are otherwise accessible to the user, additional or alternative workflows can be presented, as illustrated by the selectable workflow element 633 and associated workflow data 634.

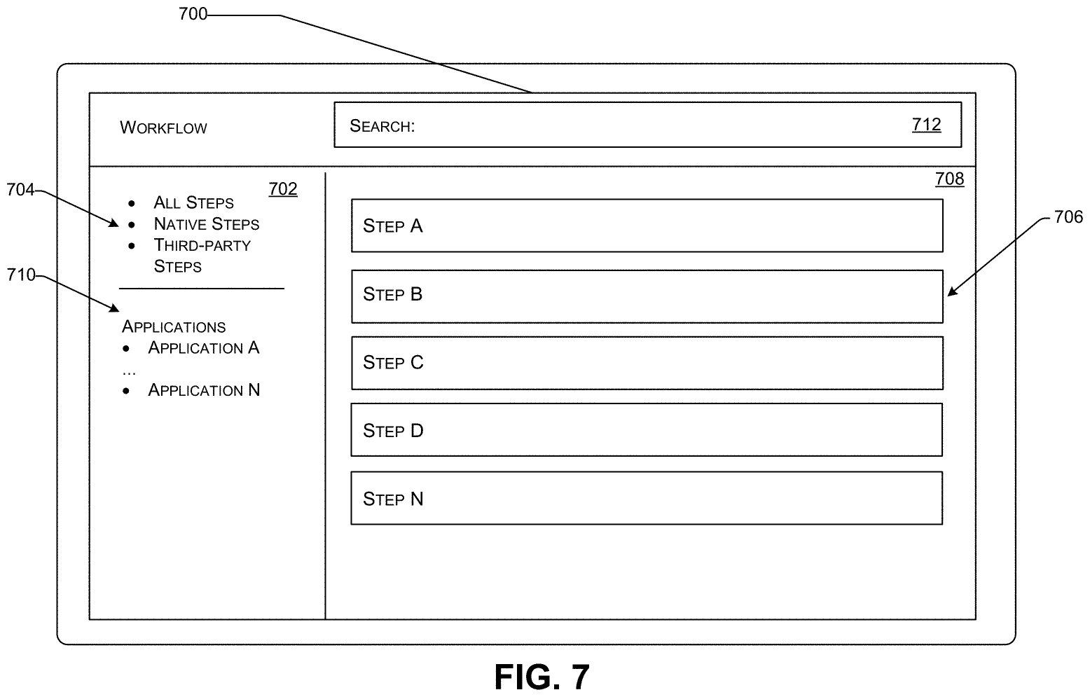

FIG. 7 illustrates another example group-based communication interface 700 that can be presented via a client device (e.g., an application or web browser associated therewith) when a user is creating a new workflow. In an example, the group-based communication interface 700 can be accessed from a tools menu or other interface that enables the user to build or edit a workflow. In some examples, such a menu can include previously generated workflows and associated steps and/or an option to generate a new workflow from one or more preexisting steps that are stored in a repository (e.g., library), as described above. The group-based communication interface 700 can comprise a user interface that can be presented in associated with a workflow builder functionality (e.g., a workflow builder user interface). That is, such a user interface can be presented to enable a user to generate a user-defined workflow comprising one or more steps, which, in some examples, can be accessible from a repository (e.g., library) as described above. As described herein, the one or more steps, when executed, can cause completion of a task. In some examples, individual steps of a workflow can be configured to be performed in a sequence. In some examples, individual of the steps can be native to the group-based communication system (e.g., provided by the group-based communication system) and/or provided by third-party applications that are external to the group-based communication system. In some examples, individual of the steps can be associated with a single application or multiple applications. That is, in some examples, a workflow can comprise multiple steps associated with multiple, different applications, some of which can be native to the group-based communication system and/or some which can be provided by a third-party. In at least one example, generation of such steps can be done via techniques described above with reference to FIGS. 3A and 3B. Examples of steps can include detecting completion of a scheduled event on a calendar, creating and/or sending an event feedback form, generating a request for time off (e.g., a PTO request), updating a calendar to reflect an approved request for time off, adding a row to a spreadsheet, removing a row from the spreadsheet, and/or the like. Examples of native steps can include a sending a message, building a form, or the like.

In some examples, individual steps can be associated with particular applications, communication channels, workspaces, users, or the like. That is, in some examples, a selectable element associated with a user interface, such as the group-based communication interface 700, can be conditionally presented based at least in part on permissions indicating particular entities that have access (e.g., are authorized to access) to the associated step. In some examples, if a step is associated with a communication channel that is shared externally (e.g., accessible to two or more different organizations associated with different organization identifiers), each of the organizations associated with the shared communication channel can access the step.

As illustrated in FIG. 7, the group-based communication interface 700 can include a pane or region 702 that allows a user to view all steps that are available to the user, a subset of steps (e.g., steps that are native to the group-based communication system, steps that have been provided by third-party applications, etc., steps associated with a user, a workspace, a communication channel, etc.), or the like. In some examples, based on permissions, some of the options presented in the pane or region 702 may not be available. For example, if steps from non-native applications (e.g., third-party applications are not enabled, installed, or otherwise not accessible per permissions or settings), the user interface element associated with the third-party application steps may not be presented and/or selectable.

By selecting a user interface element (e.g., of the user interface elements 704) associated with the group-based communication interface 700, the group-based communication server(s) 110 can cause user interface elements 706 associated with individual steps associated with the selected user interface element to be presented via the group-based communication interface 700. That is, the group-based communication interface 700 can present one or more user interface elements 706, which can be selectable, that are associated with one or more steps that can be added to a workflow. In at least one example, the step(s) represented can be step(s) that match, or otherwise correspond, to a query (e.g., the selected user interface element from the pane or region 702). In some examples, such user interface element(s) 706 can be presented in another pane or region 708 of the group-based communication interface 700. In at least one example, based on detecting a selection of one of the one or more user interface elements 706, a corresponding step can be added, by the group-based communication server(s) 110, to a workflow.

In some examples, the user interface element(s) 706 associated with step(s) can be presented in a sequence (e.g., in which such step(s) are to be combined to complete a task), based on an indication of which step(s) have been most frequently and/or recently used, based on a weighting system (e.g., step(s) associated with native applications are weighted heavier than step(s) associated with non-native applications, etc.), alphabetically, or the like. In some examples, the user interface element(s) 706 can represent a subset of a total set of steps that the user can access (e.g., is authorized or otherwise has permission to access). In such examples, the user can search for individual steps or otherwise interact with the group-based communication interface 700 to view more steps.

In some examples, the group-based communication interface 700 can include a pane or region that includes one or more user interface elements 710 that are associated with one or more applications that have steps that can be added to workflows. In some examples, by selecting a user interface element of the user interface element(s) 710, one or more steps associated with the respective application can be presented (e.g., indications thereof) via the pane or region 708. In some examples, when a user is creating or editing a workflow via the group-based communication interface 700, the user can specify an application to perform the one or more steps. After an application is selected, the user can select one or more steps associated with the application. In some examples, the user can select a step from the application and add another step from the application or another application. In some examples, the user can define a trigger event to be associated with the one or more steps and/or the workflow. When the step(s) have been added and, in some examples, a trigger event defined, the workflow can be saved, stored in the repository, and, in some examples, accessible to other users.

In some examples, the group-based communication interface 700 can include a search mechanism, which can be represented as a search bar 712 or other input mechanism. In at least one example, based at least in part on receiving an input via the search bar 712, the group-based communication server(s) 110 can access data stored in the one or more group-based communication repositories 120 (e.g., the library as described above), to determine search result(s) based on the input. In an example, if a user inputs a name of an application into the search bar 712, the group-based communication server(s) 110 can return one or more steps associated with the application (if the application has step(s) associated therewith). That is, in some examples, steps can be searchable based at least in part on the application with which they are associated. In some examples, an input into the search bar 712 can be associated with a functionality, a workflow, a user, a communication channel, a workspace, or the like. In such examples, step(s) determined to be relevant to the input can be identified in the one or more group-based communication repositories 120 (e.g., the library as described above) and indications of such can be presented via the group-based communication interface 700 (e.g., user interface element(s) associated therewith). In some examples, a search result can include applications with names that match, are related to, similar to, or otherwise correspond to, the query, and/or applications with steps that match, or otherwise correspond to, the query.

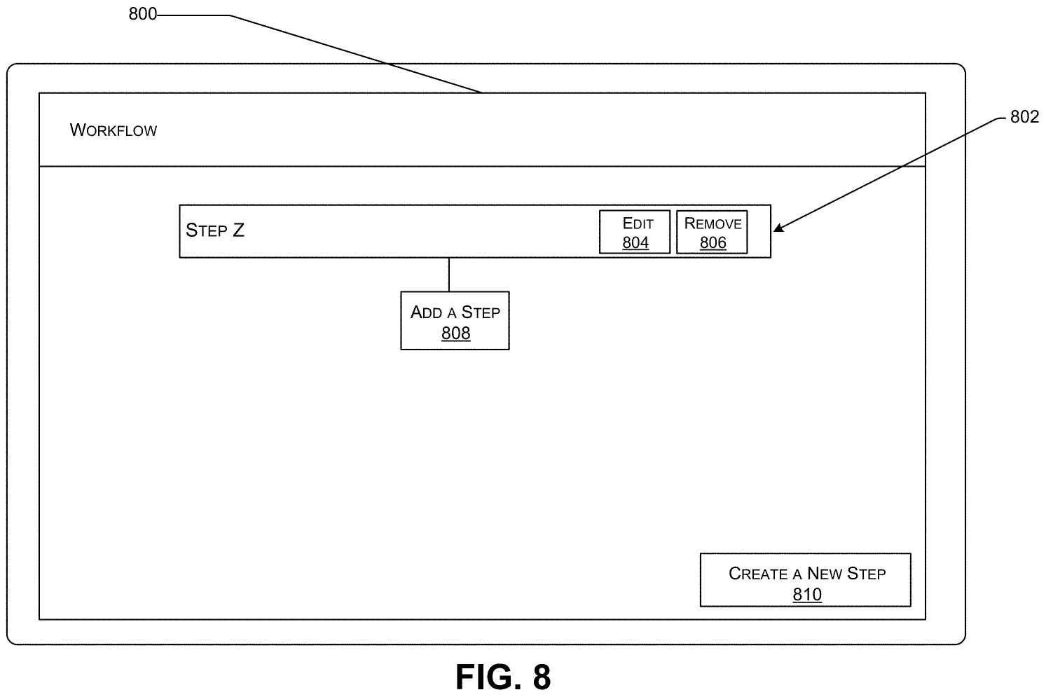

FIG. 8 illustrates an example group-based communication interface 800. In At least one example, the group-based communication interface 800 can be associated with a workflow builder functionality, as described above. In some examples, as described above, a user can generate a workflow, which can comprise one or more steps. In at least one example, the group-based communication interface 800 can present a user interface element 802 that can represent an added step in the workflow. In some examples, the user interface element 802 can include a selectable control 804 to enable the user to edit the step, as described above, and/or a selectable control 806 to enable the user to remove the step from the workflow. In at least one example, the group-based communication interface 800 can include a user interface element 808 that, when selected, can enable a user to add another step to the workflow. In at least one example, based at least in part on detecting an input associated with the user interface element 808, the client device can send an indication of such to the group-based communication server(s) 110. The group-based communication server(s) 110 can cause a user interface, such as the group-based communication interface 700 described above with reference to FIG. 7, to be presented via the client device. In some examples, aspects described above with reference to the group-based communication interface 700 can be presented as a pop-up, overlay, new user interface, or the like. The user can interact with the group-based communication interface 700 to add another step to the workflow. In such an example, another user interface element can be added to the group-based communication interface 800.

In at least one example, the group-based communication interface 800 can include a user interface element 810 that can enable a user to create a new step (e.g., a step that is not currently stored in the repository). In at least one example, based at least in part on receiving an indication of a selection of the user interface element 810, the group-based communication server(s) 110 can enable the user to provide application extension data, trigger event data, and the like to create a new step. In such an example, the new step can be added to the repository for use in building other workflows.

FIGS. 7 and 8 can enable users using workflow building functionality to find and discover workflow steps from applications associated with a workspace, communication channel, or the like, and to determine whether certain steps are likely to be useful for them. Further, as described above, FIGS. 7 and 8 enable a user to build a workflow using steps from the same or different applications. Such a workflow can be referred to herein as a “user-generated” workflow.

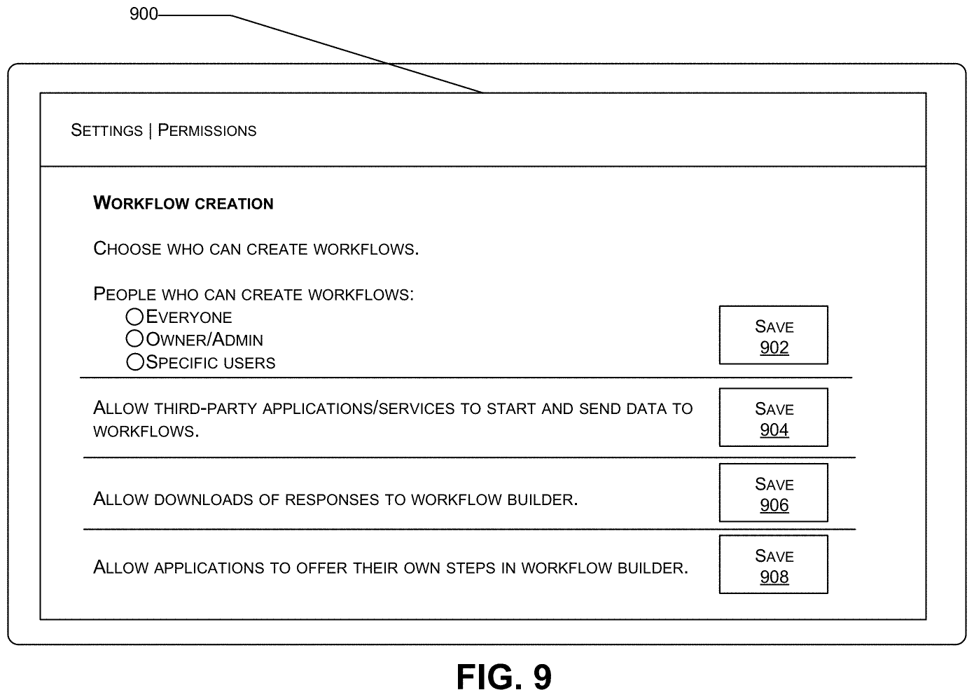

FIG. 9 illustrates an example group-based communication interface 900 which a user can interact with to provide inputs associated with permissions. In at least one example, a user can interact with the group-based communication interface 900 to designate users who can create workflows (e.g., users who have permission to create workflows), indicate whether third-party applications/services can start and/or send data to workflows, indicate whether responses can be downloaded, indicate whether applications can offer their own steps in workflow builder, and/or the like. Each permission can be associated with a selectable control (e.g., 902-908) that can be selected to save the input associated with the permission.

The interfaces described above with reference to FIGS. 6-9 are non-limiting examples of interfaces that can be presented to facilitate techniques described herein. In some examples, alternative or additional data can be presented via the interfaces. In some examples, alternative or additional configurations can be presented via the interfaces. In some examples, the interfaces can be presented as graphical user interfaces, as shown. In some examples, data associated with such interfaces can be output via other interfaces (e.g., speakers, etc.). Users can interact with the interfaces 600-900 via touch input, mouse input, controller input, spoken input, haptic input, and/or the like. In some examples, individual of the user interface elements can be selectable or otherwise interactable to provide an input. User interface elements can comprise text elements, graphic elements, images, videos, or any other object that can be presented via a interface as described herein.

### Example Clauses

A. A method comprising: receiving, from a computing device of a developer associated with an application, a request to integrate a functionality of the application into a group-based communication system via an application extension, wherein the functionality is associated with one or more steps to be integrated in a to-be-generated workflow of the group-based communication system; causing a user interface to be presented via a computing device of a user associated with the group-based communication system, wherein the user interface comprises a plurality of user interface elements representative of a plurality of selectable steps, and wherein one or more selectable steps of the plurality of selectable steps are associated with the one or more steps, associated with the application, to be integrated in the to-be-generated workflow; receiving, from the computing device of the user, a selection of a user interface element of the plurality of user interface elements, wherein the user interface element corresponds to a step of the one or more steps; and adding the step to a workflow by associating a portion of application extension data and a trigger event identifier associated with the step with the workflow.

B. The method as paragraph A recites, further comprising in response to receiving the request, causing an input user interface to be presented via the computing device of the developer, wherein the input user interface is configured to receive an input associated with the application extension data associated with the application extension, wherein the application extension data comprises one or more input variables associated with the one or more steps.

C. The method as paragraph A or B recites, wherein one or more indications of one or more steps are stored in a repository of the group-based communication system, the method further comprising accessing the repository prior to causing the user interface to be presented.

D. The method as any of paragraphs A-C recites, further comprising causing one or more user interface elements, of the plurality of user interface elements, associated with the one or more steps to be presented via the user interface based at least in part on a determination that the computing device of the user has the application installed thereon and that at least one of the user computing device of the user or the user is authorized to access the one or more steps.

E. The method as any of paragraphs A-D recites, wherein the workflow comprises a plurality of selected steps including the step, wherein the plurality of selected steps, when executed in a sequence, cause completion of a task.

F. The method as any of paragraphs A-E recites, wherein a selected step of the plurality of selected steps is created while the user interface is being presented, and wherein the selected step is stored in a repository associated with the group-based communication system for integration into other workflows.

G. The method as any of paragraphs A-F recites, wherein the plurality of selectable steps are provided by at least one of the group-based communication system or a third-party external to the group-based communication system.

H. The method as any of paragraphs A-G recites, wherein the user interface includes a search mechanism that, in response to a search based at least in part on a name of the application, returns one or more indications of the one or more steps for display via the user interface.

I. The method as any of paragraphs A-H recites, wherein the plurality of selectable steps displayed in the user interface are stored in a repository, wherein each selectable step is associated with at least one of an application identifier or a function.

J. The method as any of paragraphs A-I recites, wherein the step is associated with at least one of generation of a form, submission of a form, or approval of a form.

K. A group-based communication system comprising: one or more processors; and one or more computer-readable media comprising instructions that, when executed by the one or more processors, cause the group-based communication system to perform operations comprising: receiving, from a computing device of a developer associated with an application, a request to integrate a functionality of the application into the group-based communication system via an application extension, wherein the functionality is associated with one or more steps to be integrated in a to-be-generated workflow of the group-based communication system; causing a user interface to be presented via a computing device of a user associated with the group-based communication system, wherein the user interface comprises a plurality of user interface elements representative of a plurality of selectable steps, and wherein one or more selectable steps of the plurality of selectable steps are associated with the one or more steps, associated with the application, to be integrated in the to-be-generated workflow; receiving, from the computing device of the user, a selection of a user interface element of the plurality of user interface elements, wherein the user interface element corresponds to a step of the one or more steps; and adding the step to a workflow by associating a portion of application extension data and a trigger event identifier associated with the step with the workflow.

L. The group-based communication system as paragraph K recites, wherein causing the plurality of user interface elements to be presented via the user interface is based at least in part on a determination that at least one of the computing device of the user or the user is authorized to access the step.

M. The group-based communication system as paragraph K or L recites, the operations further comprising: receiving, from the computing device of the user, a search query associated with at least one of the application or the step; performing a search of a repository storing indications of at least the plurality of selectable steps; and causing the plurality of user interface elements to be presented via the user interface in response to receiving the search query, wherein the plurality of user interface elements are presented as a search result.

N. The group-based communication system as any of paragraphs K-M recites, wherein the workflow comprises a plurality of selected steps including the step, wherein the plurality of selected steps, when executed in a sequence, cause completion of a task.

O. The group-based communication system as paragraph N recites, wherein the application is associated with a third-party external to the group-based communication system, and individual of the plurality of selected steps are provided by at least one of the group-based communication system, the third-party, or another third-party external to the group-based communication system.

P. One or more computer-readable media comprising instructions that, when executed by one or more processors, cause the one or more processors to perform operations comprising: receiving, from a computing device of a developer associated with an application, a request to integrate a functionality of the application into a group-based communication system via an application extension, wherein the functionality is associated with one or more steps to be integrated in a to-be-generated workflow of the group-based communication system; causing a user interface to be presented via a computing device of a user associated with the group-based communication system, wherein the user interface comprises a plurality of user interface elements representative of a plurality of selectable steps, and wherein one or more selectable steps of the plurality of selectable steps are associated with the one or more steps, associated with the application, to be integrated in the to-be-generated workflow; receiving, from the computing device of the user, a selection of a user interface element of the plurality of user interface elements, wherein the user interface element corresponds to a step of the one or more steps; and adding the step to a workflow by associating a portion of application extension data and a trigger event identifier associated with the step with the workflow.

Q. The one or more computer-readable media as paragraph P recites, wherein a selected step of the plurality of selected steps is created while the user interface is being presented, and wherein the selected step is stored in a repository associated with the group-based communication system for integration into other workflows.

R. The one or more computer-readable media as paragraph P or Q recites, wherein the user interface includes a search mechanism that, in response to a search based at least in part on a name of the application, returns one or more indications of the one or more steps for display via the user interface.

S. The one or more computer-readable media as any of paragraphs P-R recites, wherein the plurality of selectable steps displayed in the user interface are stored in a repository, wherein each selectable step is associated with at least one of an application identifier or a function.

T. The one or more computer-readable media as any of paragraphs P-S recites, further comprising causing one or more user interface elements, of the plurality of user interface elements, associated with the one or more steps to be presented via the user interface based at least in part on a determination that the computing device of the user has the application installed thereon and that at least one of the user computing device of the user or the user is authorized to access the one or more steps.

While the example clauses described above are described with respect to one particular implementation, it should be understood that, in the context of this document, the content of the example clauses can also be implemented via a method, device, system, a computer-readable medium, and/or another implementation. Additionally, any of examples A-T may be implemented alone or in combination with any other one or more of the examples A-T.

### CONCLUSION

Many modifications and other examples will come to mind to one skilled in the art to which this disclosure pertains having the benefit of the teachings presented in the foregoing descriptions and the associated drawings. Therefore, it is to be understood that the disclosure is not to be limited to the specific examples disclosed and that modifications and other examples are intended to be included within the scope of the appended claims. Although specific terms are employed herein, they are used in a generic and descriptive sense only and not for purposes of limitation.

1. A method comprising:
receiving, from a computing device of a developer associated with an application, a request to integrate a functionality of the application into a group-based communication system via an application extension, wherein the functionality is associated with one or more steps to be integrated in a to-be-generated workflow of the group-based communication system;
causing a user interface to be presented via a computing device of a user associated with the group-based communication system, wherein the user interface comprises a plurality of user interface elements representative of a plurality of selectable steps, and wherein one or more selectable steps of the plurality of selectable steps are associated with the one or more steps, associated with the application, to be integrated in the to-be-generated workflow;
receiving, from the computing device of the user, a selection of a user interface element of the plurality of user interface elements, wherein the user interface element corresponds to a step of the one or more steps; and
adding the step to a workflow by associating a portion of application extension data and a trigger event identifier associated with the step with the workflow.

2. The method as claim 1 recites, further comprising in response to receiving the request, causing an input user interface to be presented via the computing device of the developer, wherein the input user interface is configured to receive an input associated with the application extension data associated with the application extension, wherein the application extension data comprises one or more input variables associated with the one or more steps.

3. The method as claim 1 recites, wherein one or more indications of one or more steps are stored in a repository of the group-based communication system, the method further comprising accessing the repository prior to causing the user interface to be presented.

4. The method as claim 1 recites, further comprising causing one or more user interface elements, of the plurality of user interface elements, associated with the one or more steps to be presented via the user interface based at least in part on a determination that the computing device of the user has the application installed thereon and that at least one of the user computing device of the user or the user is authorized to access the one or more steps.

5. The method as claim 1 recites, wherein the workflow comprises a plurality of selected steps including the step, wherein the plurality of selected steps, when executed in a sequence, cause completion of a task.

6. The method as claim 1 recites, wherein a selected step of the plurality of selected steps is created while the user interface is being presented, and wherein the selected step is stored in a repository associated with the group-based communication system for integration into other workflows.

7. The method as claim 1 recites, wherein the plurality of selectable steps are provided by at least one of the group-based communication system or a third-party external to the group-based communication system.

8. The method as claim 1 recites, wherein the user interface includes a search mechanism that, in response to a search based at least in part on a name of the application, returns one or more indications of the one or more steps for display via the user interface.

9. The method as claim 1 recites, wherein the plurality of selectable steps displayed in the user interface are stored in a repository, wherein each selectable step is associated with at least one of an application identifier or a function.

10. The method as claim 1 recites, wherein the step is associated with at least one of generation of a form, submission of a form, or approval of a form.

11. A group-based communication system comprising:
one or more processors; and
one or more computer-readable media comprising instructions that, when executed by the one or more processors, cause the group-based communication system to perform operations comprising:
receiving, from a computing device of a developer associated with an application, a request to integrate a functionality of the application into the group-based communication system via an application extension, wherein the functionality is associated with one or more steps to be integrated in a to-be-generated workflow of the group-based communication system;
causing a user interface to be presented via a computing device of a user associated with the group-based communication system, wherein the user interface comprises a plurality of user interface elements representative of a plurality of selectable steps, and wherein one or more selectable steps of the plurality of selectable steps are associated with the one or more steps, associated with the application, to be integrated in the to-be-generated workflow;
receiving, from the computing device of the user, a selection of a user interface element of the plurality of user interface elements, wherein the user interface element corresponds to a step of the one or more steps; and
adding the step to a workflow by associating a portion of application extension data and a trigger event identifier associated with the step with the workflow.

12. The group-based communication system as claim 11 recites, wherein causing the plurality of user interface elements to be presented via the user interface is based at least in part on a determination that at least one of the computing device of the user or the user is authorized to access the step.

13. The group-based communication system as claim 11 recites, the operations further comprising:
receiving, from the computing device of the user, a search query associated with at least one of the application or the step;
performing a search of a repository storing indications of at least the plurality of selectable steps; and
causing the plurality of user interface elements to be presented via the user interface in response to receiving the search query, wherein the plurality of user interface elements are presented as a search result.

14. The group-based communication system as claim 11 recites, wherein the workflow comprises a plurality of selected steps including the step, wherein the plurality of selected steps, when executed in a sequence, cause completion of a task.

15. The group-based communication system as claim 14 recites, wherein the application is associated with a third-party external to the group-based communication system, and individual of the plurality of selected steps are provided by at least one of the group-based communication system, the third-party, or another third-party external to the group-based communication system.

16. One or more computer-readable media comprising instructions that, when executed by one or more processors, cause the one or more processors to perform operations comprising:
receiving, from a computing device of a developer associated with an application, a request to integrate a functionality of the application into a group-based communication system via an application extension, wherein the functionality is associated with one or more steps to be integrated in a to-be-generated workflow of the group-based communication system;
causing a user interface to be presented via a computing device of a user associated with the group-based communication system, wherein the user interface comprises a plurality of user interface elements representative of a plurality of selectable steps, and wherein one or more selectable steps of the plurality of selectable steps are associated with the one or more steps, associated with the application, to be integrated in the to-be-generated workflow;
receiving, from the computing device of the user, a selection of a user interface element of the plurality of user interface elements, wherein the user interface element corresponds to a step of the one or more steps; and
adding the step to a workflow by associating a portion of application extension data and a trigger event identifier associated with the step with the workflow.

17. The one or more computer-readable media as claim 16 recites, wherein a selected step of the plurality of selected steps is created while the user interface is being presented, and wherein the selected step is stored in a repository associated with the group-based communication system for integration into other workflows.

18. The one or more computer-readable media as claim 16 recites, wherein the user interface includes a search mechanism that, in response to a search based at least in part on a name of the application, returns one or more indications of the one or more steps for display via the user interface.

19. The one or more computer-readable media as claim 16 recites, wherein the plurality of selectable steps displayed in the user interface are stored in a repository, wherein each selectable step is associated with at least one of an application identifier or a function.

20. The one or more computer-readable media as claim 16 recites, further comprising causing one or more user interface elements, of the plurality of user interface elements, associated with the one or more steps to be presented via the user interface based at least in part on a determination that the computing device of the user has the application installed thereon and that at least one of the user computing device of the user or the user is authorized to access the one or more steps.
